(19) United States
(12) Patent Application Publication
(10) Pub. No.: US 2023/0392041 A1
(43) Pub. Date: Dec. 7, 2023

(54) POLYMERIZABLE COMPOSITION FOR DENTAL TOOTH AND MATERIAL 3D PRINTING

(71) Applicants: The Regents of the University of Colorado, a body corporate, Denver, CO (US); Hybrid Ceramic, LLC, San Francisco, CA (US)

(72) Inventors: Jeffrey W. Stansbury, Centennial, CO (US); Matthew D. Barros, Denver, CO (US); Steven J. Sadowsky, San Francisco, CA (US)

(21) Appl. No.: 18/033,045

(22) PCT Filed: Oct. 22, 2021
(86) PCT No.: PCT/US2021/056320

§ 371 Date: Apr. 20, 2023

Related U.S. Application Data
(60) Provisional application No. 63/105,068, filed on Oct. 23, 2020.

(51) Int. Cl. C09D 175/16; C08G 18/10; C08G 18/42; C08G 18/81; A61C 13/087; A61C 13/08; B33Y 70/00; B33Y 80/00

(52) U.S. Cl. CPC C09D 175/16; C08G 18/10; C08G 18/4277; C08G 18/8116; A61C 13/087; A61C 13/081; B33Y 70/00; B33Y 80/00

(57) ABSTRACT

Polymerizable resin compositions and methods are provided for preparing shaped parts such as dental prosthetic devices and non-prosthetic dental appliances. The compositions are amenable to 3D printing and the polymerized compositions are capable of exhibiting improved strength properties, increased toughness, and good flexibility.

This application is being filed on Oct. 22, 2021, as a PCT International Patent application and claims the benefit of and priority to U.S. Provisional Application No. 63/105,068, filed Oct. 23, 2020, which is incorporated herein by reference in its entirety.

### STATEMENT REGARDING FEDERALLY SPONSORED RESEARCH

This invention was made with government support under Grant No. R21 DE028444 awarded by the National Institutes of Health. The government has certain rights in the invention.

### BACKGROUND OF THE DISCLOSURE

There are large numbers of (meth)acrylate copolymers that can be produced by bulk radical polymerization processing conditions where the resulting polymers generally display either good strength properties or good flexibility. High strength, glassy polymers inherently fail in brittle manner while lower glass transition temperature (Tg) polymers that presumably offer greater elongation to failure, undergo deformation at relatively low stress levels due to low modulus character.

Urethane (meth)acrylate monomers and oligomers such as 1,6-bis (methacryloxy-2-ethoxycarbonylamino)-2,2,4(2,4,4)-trimethylhexane (UDMA) are used as components of photopolymer formulations. Dental matrix resins comprising UDMA, known as a moderately high viscosity base monomer, and methacrylic acid (MAA), a low viscosity acidic monomer are known. Mechanical strength values of polymers prepared using UDMA/MAA resins were reported to be higher than those obtained with UDMA resin or with a conventional Bis-GMA/TEGDMA/UDMA resin. Tanaka et al., “Polymer properties of resins composed of UDMA and methacrylates with the carboxyl group.” Dental Materials Journal 2001; 20:206-215.

Unfortunately, while polymers prepared from UDMA/MAA have high strength, they are also relatively hydrophilic, which promotes staining and may compromise long-term material properties when applied in dental and other applications. A denture tooth material that has greater strength and toughness than dental composite restoratives while also offering exceptional clinical performance, durability and esthetic stability in the presence of water is desirable.

US20150257985A1, Sadowsky and Stansbury, discloses that urethane (meth)acrylate monomers and oligomers, which are widely used as key components of many photopolymer formulations, could be strengthened and simultaneously toughened by the addition of an acidic comonomer. That type of materials performance relies on non-covalently reinforced polymer networks that increase mechanical strength of polymers while also enhancing toughness. The inclusion of the comonomer (ISMA) controlled water uptake without introducing phase separation or compromising mechanical properties.

However, highly crosslinked polymeric materials derived from radical-based processing pathways (thermal, redox, photochemical and controlled radical approaches), are currently unable to achieve both a high modulus that effectively provides glassy polymer character while accommodating large recoverable degrees of deformation without fracture.

Engineering plastics (such as polyether ether ketone, PEEK) are known to provide strength with extensive deformation capability; however, the degree of recovery from deformation in those materials is limited once proceeding beyond their linear elastic limit (i.e. yield point) and they cannot be produced via radical processes and are not photocurable or compatible with SLA (Stereolithography), DLP (Digital light processing) and other photo-based 3D printing platforms.

There is a need for photopolymer materials amenable to 3D printing that are capable of delivering very high mechanical strength coupled with high toughness that are also tolerant of aqueous-based storage conditions and this represents an unmet need for dentistry as well as innumerable other areas in the huge world of additive manufacturing as well as radical-based polymeric thermoset molding in general.

### SUMMARY OF THE DISCLOSURE

The present disclosure provides polymerizable compositions comprising radically polymerizable networks that offer a broad range of tunable modulus along with high strength, high toughness and high resiliency following extensive deformation that is fully recoverable without need for thermal processing. The compositions and materials provided herein expand the potential uses that can be considered for polymeric structures in many applications including their use as molded thermosets and high-performance 3D printable formulations.

The disclosure provides a class of novel urethane (meth)acrylate monomers based on a variety of polycaprolactone (PCL) core structures, which yield remarkably strong, stiff and tough copolymers that can tolerate and recover from extreme deformation when prepared as copolymers that balance or exceed the urethane functionality with appropriate amounts of selected acidic comonomers.

Methods and compositions are provided comprising copolymerizing PCL urethane (meth)acrylate monomers with an acidic monomer such as methacrylic acid to obtain copolymers that have flexural moduli in the <1 to >4 GPa range and flexural strength in the 80-200 MPa range, and that most notably can withstand flexure under ambient conditions to dramatic extents and in many cases to the limits that can be imposed in standard testing protocols. Further, these significantly strain-deformed copolymers can then spontaneously recover their initial shape and properties upon release of the load. In tension, these materials exhibit outstanding elongation to failure compared to other known high modulus, high strength radically produced, densely crosslinked network polymers.

A polymerizable resin composition is provided comprising PCL urethane (meth)acrylate monomer(s), and acidic comonomer(s). The ratio of the urethane moieties from the PCL urethane (meth)acrylate monomer(s) and the acidic moieties from the acidic comonomer(s) may be formulated in proportions of urethane:acidic moiety ratios of 1:1 to 1:10, 1:1 to 1:5, or 1:1 to 1:3. In some embodiments the ratio of urethane:acidic moieties is 1:1.2 to 1:10, 1:1.3 to 1:6, or 1:2 to 1:5. Surprisingly, the present disclosure provides polymerizable formulations for preparing polymers with higher mechanical strength properties when the proportion of the acid functionality exceeds the urethane functionality. This effect is not disclosed by Tanaka et al., 2001 or US 2015/0257985A1, Sadowsky and Stansbury, which show a synergistic maximum in mechanical strength when the urethane and acid group ration is ˜1:1 and a sharp drop-off with higher acid concentrations. In the presently disclosed polymerizable compositions comprising PCL urethane (meth)acrylate monomer(s) and acidic comonomer(s), higher acid content can yield even better results than when the functional groups are stoichiometrically balanced.

In some embodiments, the polymerizable resin composition comprises a PCL urethane (meth)acrylate monomer and acidic monomer in urethane-acid functional group ratios of from 1:1 to 1:20, 1:2 to 1:15, or 1:3 to 1:10. In some embodiments, the ratio of the urethane and acidic functional groups in the respective PCL urethane (meth)acrylate monomer and acidic monomer may be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, or 1:20, or any ratio in between.

In some embodiments, fully formulated unfilled polymerizable resin compositions of the disclosure exhibit a viscosity of no more than 1000 mPa.s, no more than 500 mPa.s, no more than 300 mPa.s, or no more than 100 mPa.s at ambient temperature.

In some embodiments, photocured copolymer compositions comprising a PCL urethane (meth)acrylate monomer, and an acidic monomer, exhibit a flexural modulus of greater than 1.0 GPa, 2.0 GPa, 3.0 GPa, 4.0 GPa or higher; or from 1-5 GPa, from 2-5 GPa, or from 3-5 GPa.

In some embodiments, the photocured copolymer compositions comprising a PCL urethane (meth)acrylate monomer, and an acidic monomer, exhibit a the flexural strength of greater than 50 MPa, 75 MPa, 100 MPa, 150 MPa, or 175 MPa. In the present disclosure, mean values of 190 MPa and up to even 220 MPa flexural strength have been demonstrated.

In some embodiments, the photocured copolymer compositions comprising a PCL urethane (meth)acrylate monomer, and an acidic monomer, exhibit a mechanical toughness of greater than 200 J/m³, greater than 300 J/m³, greater than 500 J/m³, greater than 750 J/m³, greater than 1,000 J/m³, greater than 1,500J/m³, or greater than 2,000 J/m^{3 .}

In some embodiments, the photocured copolymer compositions comprising a PCL urethane poly(meth)acrylate monomer, and an acidic monomer, exhibit a conversion of about 50% or greater, greater than 55%, 75%, 85%, 90%, or greater than 95%. In some embodiments, initially formed polymers may be in the range of about 50% conversion or greater, and may be subjected to post-cure conditions to obtain polymers exhibiting conversion of at least about 90%, or 95% or greater.

In some embodiments, the photocured copolymer compositions comprising a PCL urethane (meth)acrylate monomer, and an acidic monomer, exhibit a strain at failure of greater than 4.0%, 5.0%, 8.0%, or 10.0%.

In some embodiments, the polymerizable resin composition may further comprise one or more hydrophobic monomers. For example, the hydrophobic monomer may be selected from the group consisting of isostearyl (meth)acrylate (ISMA), ethoxylated bisphenol A di(meth)acrylate (EBDMA), stearyl (meth)acrylate, lauryl (meth)acrylate, isodecyl (meth)acrylate, 2-ethylhexyl (meth)acrylate, isobornyl (meth)acrylate and cyclohexyl (meth)acrylate. In some embodiments the hydrophobic monomer is an ISMA. In some embodiments, the ISMA has one or more, two or more, three or more, four or more, or five or more branch points. Three versions of ISMA are illustrated in FIG. 5. All have at least one branch point along the C18 alkyl chain, which renders the monomer an amorphous liquid rather than a waxy, semi-crystalline solid in the case of stearyl (meth)acrylate. In some embodiments, the ISMA has three or more branch points. In some embodiments, the ISMA has five or more branch points. In some embodiments, the ISMA has a structure shown in FIG. 5. Common ISMA has a single branch point. The branching may be important to avoid crystallinity involving the C18 chains. However, the highly branched ISMA works very well as a significantly hydrophobic comonomer that interdigitates the multi-branch points into the overall polymer network, without sacrificing the mechanical strength potential that the other urethane and acidic monomers contribute. The weight ratio of PCL urethane (meth)acrylate monomers plus acidic monomers compared to hydrophobic monomers may be selected from about 99:1 to 50:50; 90:10 to 60:40; 85:15 to 75:25, or about 80:20.

In some embodiments, the ratio of the PCL urethane poly(meth)acrylate monomer urethane moiety to acidic monomer acidic moiety is from 1:1 to 1:20, 1:2 to 1:15, or 1:3 to 1:10.

In some embodiments, a polymerizable resin composition is provided comprising a PCL urethane (meth)acrylate monomer comprising a chemical structure according to Formula (I):

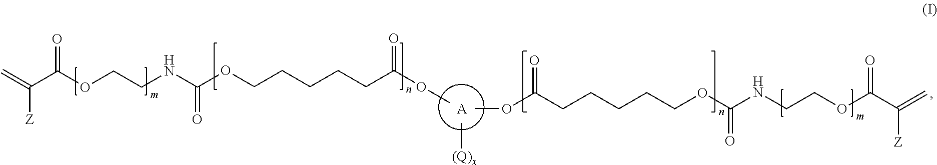

wherein A=aliphatic, aromatic, alkoxyalkyl, alkoxy, hydroxyalkyl, or alkoxycarbonyl core structure; independently each n=0-12, where at least one n is not equal to 0; x=0-6; Z=CH₃ or H; each m=1-5; and Q=OH or, where

### R=

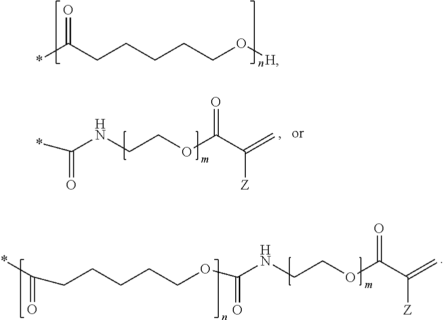

In some embodiments, a PCL urethane (meth)acrylate monomer comprising a chemical structure is provided according to Formula (I) wherein A=aromatic, straight or branched chain C₂₋₁₂ aliphatic or alkylalkoxy; independently each n=1-5; x =0-3, m=1-3, and Q=OH or OR.

In some embodiments, a PCL urethane (meth)acrylate monomer is provided comprising a chemical structure according to Formula (I) wherein A=aromatic, straight or branched chain C₂₋₁₂ aliphatic or alkylalkoxy; average n=0.3-12; x=0-6; m =1-5, and Q=OH or OR.

In some embodiments, a PCL urethane (meth)acrylate monomer comprising a chemical structure is provided according to Formula (I) wherein A=aromatic, straight or branched chain C₂₋₁₂ aliphatic or alkylalkoxy; average n=0.5-5; x=0-3, m =1-3, and Q=OH or OR.

In some embodiments, the acidic monomer is selected from the group consisting of methacrylic acid (MAA), acrylic acid, itaconic acid, mono-2-(methacryloyloxy) ethyl maleate, pyromellitic dianhydride glycerol dimethacrylate, 2-carboxyethyl acrylate, 2-carboxyethyl acrylate oligomer, mono-2-(methacryloyloxy) ethyl succinate, glycerol dimethacrylate/succinate adduct, 1,3-glycerol dimethacrylate/maleate adduct, bis[2-(methacryloyloxy)ethyl] phosphate, or ethylene glycol methacrylate phosphate.

The polymerizable resin composition may further include a surfactant. The surfactant may be selected from sodium dodecyl sulfate (SDS), ammonium lauryl sulfate, Cetyl trimethylammonium bromide (CTAB), Cetylpyridinium chloride (CPC), Polyethoxylated tallow amine (POEA); Dodecyl betaine, Dodecyl dimethylamine oxide, sodium lauryl sulfate and polyether modified polydimethyl-siloxane (BYK®-307).

The polymerizable resin composition may further include an initiator. The initiator may be selected from the group consisting of a thermal initiator, photoinitiator, redox initiator, and controlled radical initiator.

A method is provided for creating a two-dimensional film or a three-dimensional shaped part comprising molding, free-form fabricating, or printing of a polymerizable resin composition according to the present disclosure. The film or shaped part may be a prosthetic device or a non-prosthetic appliance. The prosthetic device or non-prosthetic appliance may be a medical or dental device or appliance. A method of preparing a shaped part is provided comprising 3-dimensional (3D) printing of a polymerizable resin composition according to the present disclosure. In some embodiments, a method for providing one-step molded parts is provided, which can be polymerized by heat, redox or light. This may be applied to 2D films as well as 3D parts. Regarding the photopolymerization-based 3D printing process, the 3D part may be constructed in either a continuously formed or sequentially layered 3D printing process that results from the spatially structured photopolymerization applied either continuously or sequentially to create each layer. Either way, the part may be photocured during the entire building process and optionally subjected to post-polymerization cure applied at the end. In some embodiments, the extent of polymerization may be sufficient to allow the printed part along with any supporting structure to be self-supporting. Optionally, final polymerization (post-cure) may then be used as needed to complete the processing of the part.

A method of preparing a shaped part is provided comprising 3-dimensional (3D) printing of a polymerizable resin composition according to the present disclosure to form a shaped part; and polymerizing the shaped part. The printed part may be subjected to post-cure treatment. The shaped part may be a dental prosthetic device or dental non-prosthetic appliance. The dental prosthetic device may be a crown, bridge, denture, implant, or other prosthetic device. The dental non-prosthetic appliance may be an aligner, dental splint, retainer, mouthguard, whitening tray, or other intraoral appliance. For example, the dental non-prosthetic appliance may fit over existing teeth instead of taking the place of missing tissue. The shaped part may be a biomedical part such as for use in bone repair, cardiovascular stents, or other biomedical part. Methods for use of the compositions of the disclosure may include dental applications, biomedical applications, or non-dental, non-medical applications such as, for example, an automotive, aerospace, electrical, plumbing, or other applications.

A method of preparing a shaped part such as a dental appliance or dental prosthetic device is provided comprising: dispensing a polymerizable resin composition of the disclosure; shaping the mixture into the form of the shaped dental prosthetic device; and optionally photopolymerizing the shaped mixture. The dental appliance may be a dental aligner appliance, bite splint, retainer, whitening tray, or other dental appliance. The dental prosthetic device may be a crown, bridge, denture, implant, or other prosthetic device.

A two-dimensional film or a three-dimensional shaped part is provided comprising a polymer created from the polymerization of the polymerizable resin composition according to the disclosure.

A two-dimensional film or a three-dimensional shaped part is provided comprising a polymer created from the polymerization of the polymerizable resin composition according to the disclosure in admixture with one or more fillers.

In some embodiments, a dental prosthetic device is provided comprising a polymer created from the polymerization of the resin according to the disclosure in admixture with one or more fillers.

A polymerizable composition is provided comprising: particles of filler, a PCL urethane (meth)acrylate monomer, and an acidic monomer. In some embodiments, the optional filler may be present at 0-25 wt %, 2-20 wt % or 5-15 wt % of the total material weight. In some embodiments, a filler may be present at from 25-95 wt %, 30-92 wt %, 40 wt % to 90 wt %; 50 wt % to 85 wt %; or 70 wt % to 80 wt % of the total material weight.

A dispensing device is provided comprising an unpolymerized quantity of a polymerizable composition comprising a PCL urethane (meth)acrylate monomer, and an acidic monomer. The composition may include a hydrophobic monomer. In some embodiments, the composition comprises one or more fillers.

A PCL urethane (meth)acrylate monomer or monomer composition is provided comprising a chemical structure according to Formula (Ia):

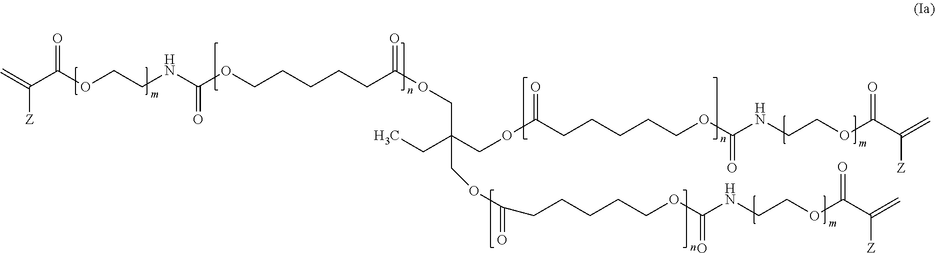

wherein each m is independently=1 to 5; each Z=CH₃ or H; and each n is independently=0 to 12, where at least one n is not equal to 0. In some embodiments, each n is independently=1-9; each m=1 to 2. In some embodiments, average n=0.3-12; and each m=1 to 5. In some embodiments, average n=0.3-9; and each m=1 to 2.

A PCL urethane (meth)acrylate monomer or monomer composition is provided comprising a chemical structure according to Formula (Ib):

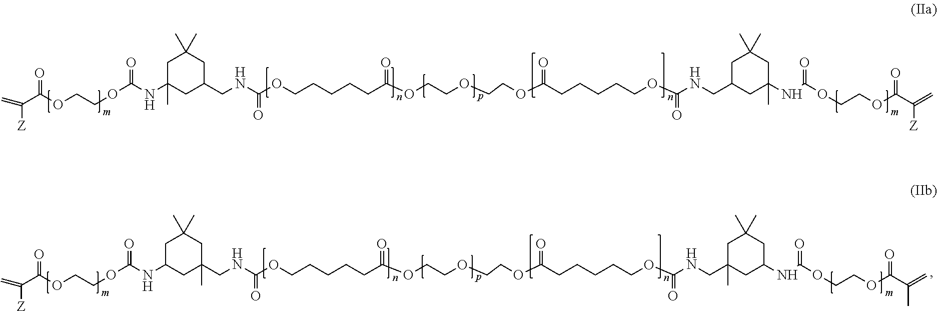

wherein each m is independently=1 to 5; Z=CH₃ or H; each n is independently=0 to 12 where at least one n is not equal to 0, and p=0 to 12. In some embodiments, each n is independently=1 to 9, p=1 to 10; each m is independently=1 to 2. In some embodiments, m=1 to 2, each n is independently=1 to 3, and p=1-6. In some embodiments, average n=0.3-12; and each m=1 to 5. In some embodiments, average n=0.3-9; each m=1 to 2; and p=1-2.

A PCL tetraurethane di(meth)acrylate monomer is provided according to Formula (IIa) or (IIb):

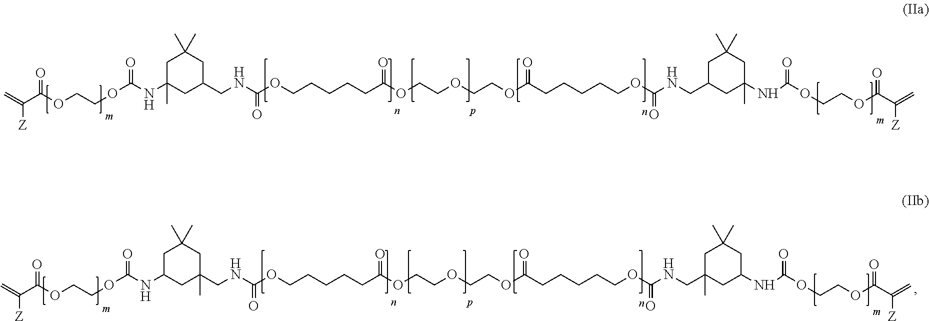

wherein n=1 to 10, m=1 to 5, p=0 to 12, and z=H or CH₃; optionally wherein n=1 to 5, m=1 to 3, p=1 to 6.

In some embodiments, the disclosure provides a polymerizable resin composition comprising two or more, or three or more different PCL urethane (meth)acrylates monomers according to Formula (I), wherein x=0-6, and an acidic monomer. For example, a polymerizable resin composition is provided comprising a first PCL urethane (meth)acrylate monomer according to formula (I) wherein x=0, 1, 2, 3, 4, 5, or 6; a second PCL urethane (meth)acrylate monomer according to formula (I) wherein x=0, 1, 2, 3, 4, 5, 6, and an acidic monomer, wherein the first and second monomers have different values for x.

In some embodiments, a composition is provided comprising a first PCL urethane (meth)acrylate monomer according to formula (I) wherein x=0, a second PCL urethane (meth)acrylate monomer according to formula (I) wherein x=1, and an acidic monomer. In some embodiments, a composition is provided comprising a first PCL urethane (meth)acrylate monomer according to formula (I) wherein x=0, a second PCL urethane (meth)acrylate monomer according to formula (I) wherein x=2, and an acidic monomer.

In some embodiments, the disclosure provides a polymerizable resin composition comprising a PCL diurethane di(meth)acrylate monomer according to Formula (Ib) and a PCL triurethane tri(meth)acrylate monomer according to Formula (Ia) in a mass ratio of from 5:1 to 1:5, 2:1 to 1:2, or about 1:1, and further comprising an acidic monomer.

In some embodiments, the disclosure provides a polymerizable resin composition comprising a PCL diurethane di(meth)acrylate monomer according to Formula (Ib) and a PCL tetraurethane tetra(meth)acrylate monomer according to Formula (I), where x=2, in a mass ratio of from 5:1 to 1:5, 2:1 to 1:2, or about 1:1, and further comprising an acidic monomer.

In some embodiments, the acid-urethane functional copolymers according to the disclosure exhibit hydrolytic stability when stored in water for at least 18 months at ambient temperature, as evidenced by visual retention of shape edges and surface gloss.

### BRIEF DESCRIPTION OF THE DRAWINGS

FIG. 1 shows an exemplary synthetic chemical Scheme IA for production of a generic polycaprolactone (PCL) polyurethane poly(meth)acrylate monomer according to Formula (I). A polyol (1) having a core structure A, where A=heteroatom substituted or unsubstituted aliphatic or aromatic core structure, and x=0-6, is treated with caprolactone and a catalyst to provide a polycaprolactone (PCL) polyol (2), where independently each n=0-12, wherein at least one n≠0; and Q=OH or OR, where R =*-[(C═O )(CH₂)₅O]ₙ-H. The PCL polyol is treated with an isocyanato (meth)acrylate (3), wherein m=1-5, and Z=CH₃ or H, to provide the PCL polyurethane poly(meth)acrylate monomer (I) for use according to the present disclosure.

FIG. 2 shows an exemplary synthetic chemical Scheme IB for production of a PCL triurethane tri (meth)acrylate according to Formula (Ia). The PCL triol (4) may be provided synthetically by any appropriate route of synthesis, for example, by the route of Scheme Ia wherein polyol core structure A is 2-ethyl-2-(hydroxymethyl) propane-1,3-diol, which is treated with caprolactone and a catalyst, or the PCL triol may be purchased commercially (Sigma-Aldrich). The PCL triol may be treated with about 3 molar equivalents of an isocyanato (meth)acrylate (3) such as 2-isocyanatoethyl methacrylate (IEM, m=1, Z=CH₃); or extended 2-isocyanatoethyl (meth)acrylate (IEMₑₓₜ, m=2, Z=CH₃), to provide the PCL triurethane tri(meth)acrylate monomer (Ia) for use according to the present disclosure. Alternatively, the PCL triol may be treated with about 3 molar equivalents of an isocyanatoethyl acrylate (IEA) to provide a PCL triurethane triacrylate monomer for use according to the present disclosure.

FIG. 3 shows an exemplary synthetic chemical Scheme II for production of a PCL diurethane di (meth)acrylate monomer according to Formula (Ib).

Dicaprolactone diol having a diethylene glycol core structure (5)may be prepared according to the disclosure or purchased commercially (Sigma-Aldrich) and treated with about 2 molar equivalents of an isocyanato (meth)acrylate such as 2-isocyanatoethyl methacrylate (3, IEM, m=1, Z=CH₃) or extended 2-isocyanatoethyl methacrylate (3, IEMₑₓₜ, m=2, Z=CH₃), to provide the PCL diurethane di(meth)acrylate monomer (Ib) for use according to the present disclosure.

FIG. 4 shows Scheme III with exemplary acidic monomers including methacrylic acid (MAA), acrylic acid, itaconic acid, mono-2-(methacryloyloxy)ethyl maleate, pyromellitic dianhydride glycerol dimethacrylate, 2-carboxyethyl acrylate, 2-carboxyethyl acrylate oligomer, mono-2-(methacryloyloxy)ethyl succinate, glycerol dimethacrylate/succinate adduct, 1,3-glycerol dimethacrylate/maleate adduct, bis[2-(methacryloyloxy) ethyl] phosphate, and ethylene glycol methacrylate phosphate.

FIG. 5 shows Scheme IV with chemical structures of comparative non-PCL urethane methacrylate monomer UDMA, and examples of hydrophobic monomers MMA, ISMA, cyclohexyl methacrylate, stearyl methacrylate, lauryl methacrylate, 2-ethylhexyl methacrylate, isodecyl methacrylate, isobornyl methacrylate and EBDMA.

Methacrylate versions are shown in FIG. 5, but acrylate versions may also be employed.

FIG. 6 shows a graph of molecular weight vs. fraction of molecules with a certain molecular weight for a polydisperse polymer sample, illustrating weight-average molecular weight (Mw), as the average molecular weight of a polydisperse polymer sample, averaged to give higher statistical weight to larger molecules; and number-average molecular weight (Mn), as the average molecular weight of a polydisperse polymer sample, averaged to give equal statistical weight to each molecule.

FIG. 7 shows a graph of dynamic mechanical analysis (DMA) results of temperature (deg C) vs. Tan Delta for selected homopolymers and copolymers of the disclosure. The copolymer prepared from MAA added to the PCL diol₅₃₀ + IEM of Formula (Ib), where n˜2, p=1, m=1, exhibits a copolymer glass transition temperature (Tg) rising and broadening out to about 100° C. (curve B), compared to homopolymer (A) from PCL diol₅₃₀ + IEM of Formula (Ib) (curve A). An unusual attribute of the PCL₃₀₀ triol + IEM homopolymer of Formula (Ia) is the very broad glass transition temperature (Tg; V) that spans from <0° C. to more than 150° C. (curve C). The inclusion of methacrylic acid (MAA) with PCL₃₀₀ triol + IEM formulation exhibited an even broader copolymer Tg wherein the thermal transition stretched below room temperature and increased the high temperature transition that extended to —190° C. (curve D).

FIG. 8 shows ¹H-NMR of PCL urethane methacrylate monomer PCL-Diol₅₃₀ +IEM.

FIG. 9 shows ¹H-NMR of PCL urethane methacrylate monomer PCL-Diol₅₃₀ +IEM_{ext.}

FIG. 10 shows ¹H-NMR of PCL urethane methacrylate monomer PCL-Triol₃₀₀ +IEM.

FIG. 11 shows ¹H-NMR of PCL urethane methacrylate monomer PCL-Triol₃₀₀ +IEM_{ext.}

FIG. 12 shows ¹H-NMR of PCL urethane methacrylate monomer PCL-Diol₂₀₀₀ +IEM.

FIG. 13 shows ¹H-NMR of PCL urethane methacrylate monomer PCL-Diol₁₂₅₀ +IEM.

FIG. 14 shows a stress-strain plot for the 3-point bending testing of the 1:1 PCL-diol₅₃₀+IEM/PCL-triol₃₀₀+IEM with a stoichiometric balance of MAA relative to the overall urethane group functionality. It highlights the unusual high stress plateau that is observed with these PCL-based materials. It is primarily this characteristic that is responsible for the high levels of toughness achieved with these polymers.

FIG. 15 shows an exemplary synthetic chemical Scheme V for production of a PCL tetraurethane di(meth)acrylate monomer according to Formula (IIa). 2 moles of IPDI were reacted with 1 mole of PCL diol₅₃₀ followed by the reaction with 2 moles of HEMA-C1 to obtain the PCL tetraurethane di(meth)acrylate monomer of Formula (IIa).

FIG. 16 shows an exemplary synthetic chemical Scheme VI for production of a PCL tetraurethane di(meth)acrylate monomer according to Formula (IIb). 2 moles of IPDI were reacted with 2 moles of HEMA-C1 followed by reaction with 1 mole of PCL diol₅₃₀ to obtain the PCL tetraurethane di(meth)acrylate monomer of Formula (IIb).

FIG. 17 shows a stress-strain plot for repeated 3-point bending testing of the copolymer of PCL Diol-IEM + MAA (5× acid to urethane ratio) in three-point bending mode (MTS universal testing device) when subjected to repeated 5% strain or 10% strain. The plot shows that the slope and strain-dependent stress levels were quite reproducible indicating little of no damage or irrecoverable deformation was introduced through these loading/unloading cycles.

FIG. 18 shows a stress-strain plot for repeated 3-point bending testing of the copolymer of PCL Triol-IEMEG + MAA (1:1 acid to urethane ratio) in three-point bending mode (MTS universal testing device). The bar specimen spontaneously recovered its original shape upon unloading from the 2 and 5% strain and while it likely would have eventually returned from the 10 and 15% strain deformation, the recovery process was rapidly facilitated by application of heat (heat gun at ˜80° C. for 5 seconds), which immediately restored the original linear bar shape. This cyclic mechanical treatment shows that there is no change in the slope (and thus modulus) of the polymer and that the strain-dependent stress continues to reach the very impressive 180-200 MPa flexural strength levels characteristic of this material. The reproducible properties indicate that little or no damage and irrecoverable deformation based on plastic yielding or stress relaxation was introduced through these loading/unloading cycles.

FIG. 19A shows time lapse photographs of deformation recovery of PCL Triol-IEMEG + MAA (1:1 acid to urethane ratio) taken to 10% strain. The photographs show significant recovery of the copolymer.

FIG. 19B shows time lapse photographs of deformation recovery of PCL Triol-IEMEG + MAA (1:1 acid to urethane ratio) taken to 15% strain. The photographs show significant recovery of the copolymer.

FIG. 20 shows a stress-strain plot in tension using ambient dynamic mechanical analysis (DMA) for the PCL triol-IEMEG + MAA (1:1) copolymer. The plot shows significant spontaneous recovery of the copolymer.

### DETAILED DESCRIPTION

Methods and polymerizable resin compositions are provided for 3D printing of dental prosthetic devices capable of exhibiting improved strength properties and good flexibility.

The present disclosure provides polymerizable resin compositions comprising polycaprolactone (PCL) urethane poly(meth)acrylate monomers, wherein simple addition of an acid monomer significantly reduces resin viscosity compared with common reactive diluents. Notably, the resulting acid-urethane functional copolymers display dramatic increases not only in tensile and flexural modulus and strength but also in toughness.

The polymer properties can be maintained in the presence of water. The optional use of hydrophobic monomer, such as ISMA can very effectively counter the hydrophilic character of the acidic comonomer without compromising the excellent mechanical strength and toughness character of these polymers.

The toughened polymers display excellent resiliency with rapid return to initial shape and properties following extreme deformation. This behavior is unique because upon unloading, it spontaneously recovers its original shape without heating. A glassy solid that is deformed usually either undergoes brittle failure (breaks) or has a modest range of deformation from which it can elastically recover but beyond that yield point of deformation, further deformation is irrecoverable (with or without heat).

One application of these high performance photopolymers is SLA/DLP/inkjet 3D printing. Equivalent properties between printed and bulk photocured versions of these photocurable network polymers have been demonstrated that rival the properties of engineering plastics (such as polyether ether ketone, PEEK) that are not amenable to photo-processing.

Specific applications include advanced 3D printing focused on dental applications through the development of extremely high performance, photocurable resin formulations. The compositions and methods provided in the present disclosure allow high performance dental applications including, but not limited to, provisional crowns, permanent crowns, bridges, dentures, including monolithic and esthetic permanent denture appliances, and directly printed orthodontic aligners, mouth guards, bite splints, whitening trays, etc.

New photocurable materials are provided that offer remarkably high performance 3D printable polymers. Improved acid-urethane functionalized non-covalently reinforced polymer networks have been developed using new urethane methacrylates according to Formula (I) that yield low modulus, highly flexible homopolymers and that transition to very high modulus polymers that remarkably retain the extensive flexibility when copolymerized with a suitable acidic comonomer.

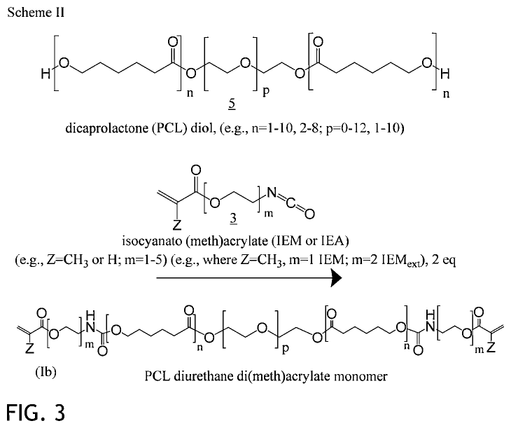

For example, a novel PCL urethane dimethacrylate monomer is provided according to Formula (Ib), FIG. 3, that following photocure exhibits a very low modulus of 0.04 GPa, (Table IB.7.f), and highly flexible homopolymer with 98% conversion under ambient photocuring conditions. The PCL₅₃₀diol +IEM monomer was transformed by the stoichiometric inclusion of an acidic monomer, methacrylic acid (MAA), to give an equally high conversion (97%) copolymer that retains extreme elastic recovery yet with a dramatically increased modulus of 1.2 GPa, (Table IB.7.g), retaining the same extensive flexibility, but about an order of magnitude increase in toughness (Table IB.8.f vs. g). This copolymer exhibits high stiffness and high resilience indicating a unique combination of a physically reinforced crosslinked network with a low glass transition temperature but high tensile and flexural modulus. These polymer samples could not be failed under extensive flexural deformation. This provides more than an order of magnitude increase in toughness and the optically clear copolymer provides excellent resiliency with rapid return to initial shape and properties following extreme deformation.

A library of urethane and acid functionalized comonomer pairs has been developed that captures this same highly desirable combination of photopolymer strength with toughness that can be maintained in the presence of water and offers the ability to tailor these materials with unfilled moduli of up to 5 GPa and flexural strength values of over 200 MPa. The present inventors have demonstrated equivalent properties between printed and bulk photocured versions of these photocurable network polymers that rival the properties of engineering plastics that are not amenable to photo-process based 3D printing.

One aim of the present disclosure is the introduction of new methods and metrics to better appreciate material/process interactions and thereby improve 3D printed materials. The disclosure provides compositions and methods comprising high performance materials designed to address unmet needs in 3D printing as applied to dentistry and beyond for creation of robust functional parts rather than models and prototypes.

Definitions

A “polymer” is a substance composed of macromolecules. A polymer macromolecule is a molecule of high relative molecular mass, the structure of which comprises the multiple repetition of units derived from molecules of low relative molecular mass.

A “branched polymer” is a polymer that includes side chains of repeat units connecting onto the main chain of repeat units (different from side chains already present in the monomers). A branched polymer refers to a non-linear polymer structure, but typically, not a network structure. Therefore, a trace forward from the branch point would not bridge back to the original main chain; i.e. minimal to no backbone crosslinking is present. A branched polymer would generally be soluble in an appropriate solvent.

A “crosslinked polymer” is a polymer that includes interconnections between chains, either formed during polymerization (by choice of monomer) or after polymerization (by addition of a specific reagent). In a crosslinked polymer network, with the crosslinks serving as branch points, it is possible to trace a continuous loop back to the backbone. The crosslinked network would be insoluble in all solvents.

A “network polymer” is a crosslinked polymer that includes two or more connections, on average, between chains such that the entire sample is, or could be, a single molecule. Limited crosslink connections per chain would be considered lightly crosslinked while numerous crosslinks would be considered highly (or heavily) crosslinked.

A “copolymer” is a material created by polymerizing a mixture of two, or more, starting compounds. The resultant polymer molecules contain the monomers in a proportion which is related both to the mole fraction of the monomers in the starting mixture and to the reaction mechanism.

A “chain transfer agent” is an intentionally added compound that terminates the growth of one polymer chain and then reinitiates polymerization to create a new chain. A chain transfer agent is used as a way to limit chain length.

A “gelation time” is the time to reach the gel point (the point at which a continuous crosslinked network initially develops) during a polymerization.

A “filler” is a solid extender which may be added to a polymer to modify mechanical, optical, rheological, electrical, thermal, flammable properties, or simply to act as an extender. The filler can be reactive or inert in the polymerization.

An “extender” is a substance added to a polymer to increase its volume without substantially altering the desirable properties of the polymer.

The term “ambient temperature” refers to 20-25° C., and “normal temperature” is 20° C.

The term “urethane monomer” refers to a monomer comprising two or more acrylate/methacylate groups and two or more urethane groups. The term encompasses various urethane dimethacrylates including, but not limited to 1,6-bis(methacryloxy-2-ethoxycarbonylamino)-2,2,4(2,4,4)-trimethylhexane (urethane dimethacrylate, UDMA, RN:72869-86-4) (RN: 41137-60-4) and bis(2-(methacryloyloxy)ethyl) 5,7,7,24,24,26-hexamethyl-10,21-dioxo-11,14,17,20-tetraoxa-2,9,22,29-tetraazatriacontanedioate (RN: 94333-55-8).

The acronym “PCL” refers to polycaprolactone formed from ring-opening of a caprolactone. The term “PCL urethane (meth)acrylate monomer” refers to a monomer comprising one or more, two or more, three or more, or four or more PCL (polycaprolactone) groups (e.g., caproic acid ester; caproate, 6-(hexanoyloxy) hexanoate, polycaproate), one or more, two or more, three or more, or four or more urethane groups, and one or more, two or more, three or more, or four or more acrylate/methacylate groups. In some embodiments, the number of reactive groups in the PCL (meth)acrylate monomers per monomer molecule can be 1, 2, 3, 4 or more.

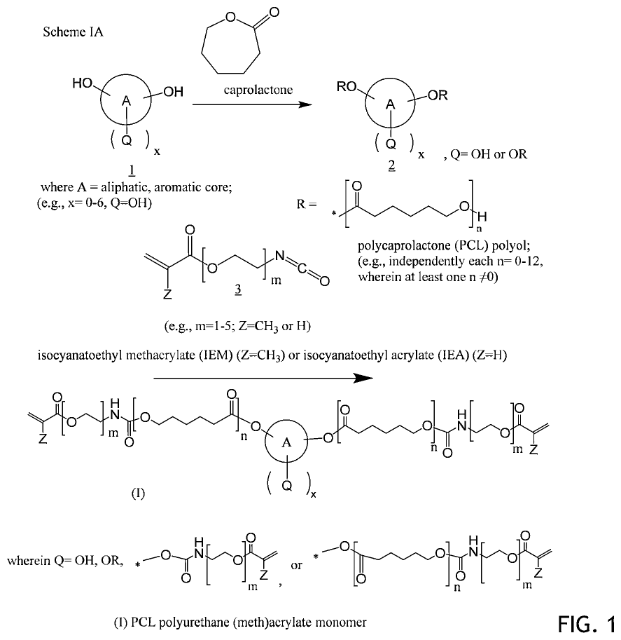

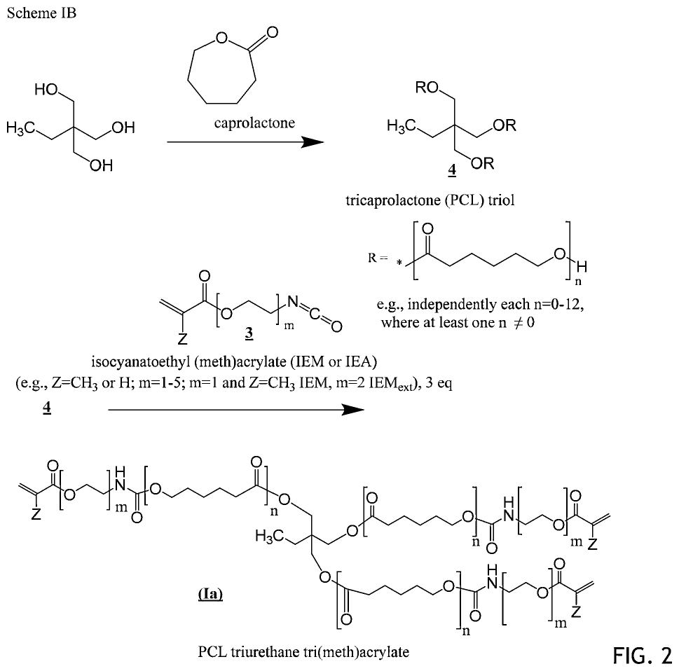

In some embodiments, the PCL (meth)acrylate monomer may comprise two or more, three or more, or four or more PCL (polycaprolactone) groups; two or more, three or more, or four or more urethane groups; and two or more, three or more, or four or more acrylate/methacylate groups. In some embodiments, the PCL (meth)acrylate monomer may comprise a chemical structure according to Formula (I) of FIG. 1. In some embodiments, the PCL (meth)acrylate monomer may be a PCL triurethane tri(meth)acrylate monomer. The PCL triurethane tri(meth)acrylate monomer may comprise a chemical structure according to Formula (Ia) of FIG. 2. In some embodiments, the PCL (meth)acrylate monomer may be a PCL diurethane di(meth)acrylate monomer. In some embodiments, the PCL diurethane di(meth)acrylate monomer comprises a chemical structure according to Formula (Ib) of FIG. 3.

The term “acidic monomer” refers to a monomer having at least one acrylate/methacylate group and at least one carboxylic acid group or phosphoric acid group. The term encompasses but is not limited to methacrylic acid (MAA).

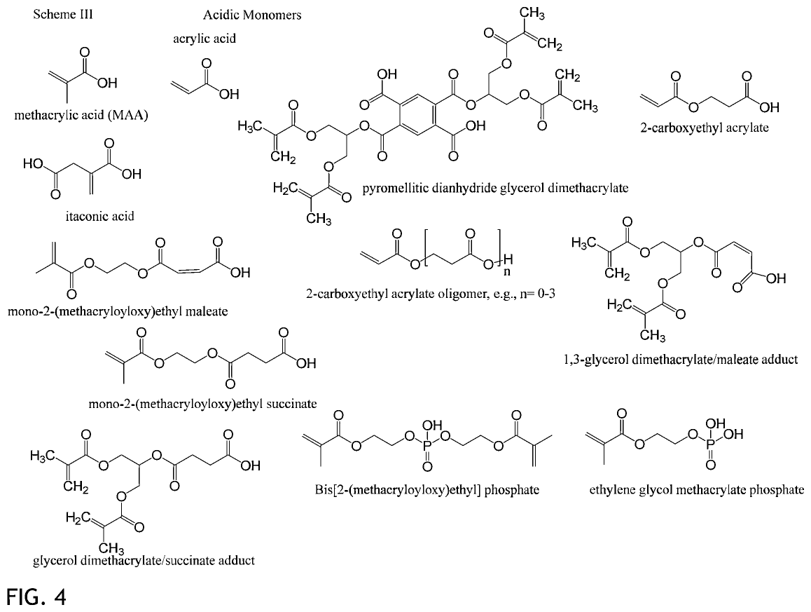

Exemplary acidic monomers are shown in FIG. 4. For example, the acidic monomer may be methacrylic acid (MAA), acrylic acid, itaconic acid, mono-2-(methacryloyloxy) ethyl maleate, pyromellitic dianhydride glycerol dimethacrylate, 2-carboxyethyl acrylate, 2-carboxyethyl acrylate oligomer, mono-2-(methacryloyloxy)ethyl succinate, glycerol dimethacrylate/succinate adduct, 1,3-glycerol dimethacrylate/maleate adduct, bis[2-(methacryloyloxy)ethyl] phosphate, or ethylene glycol methacrylate phosphate.

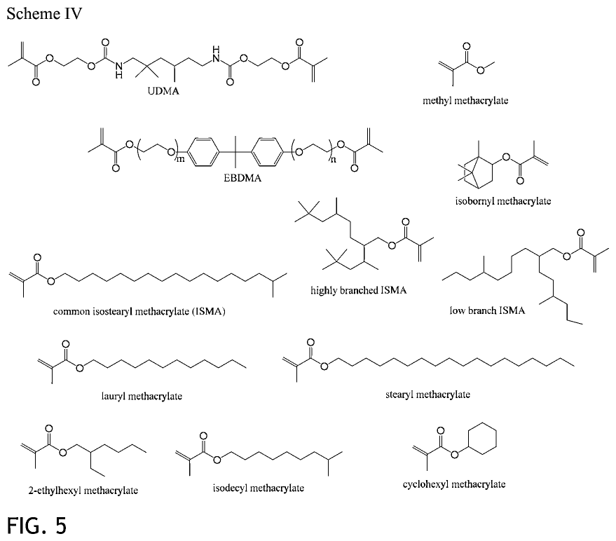

The term “hydrophobic monomer” refers to a monomer having one or more acrylate/methacrylate groups and no urethane, carboxylic acid, or hydroxyl functional groups. Hydrophobicity of monomers can also be assessed and compared using the n-octanol-water distribution coefficient (log P_{o/w}). For example, methyl methacrylate has a log octanol/water partition coefficient (log Kow) of 0.79. U.S. Environmental Protection Agency. Health and Environmental Effects Profile for Methyl Methacrylate. EPA/600/x-85/364. Environmental Criteria and Assessment Office, Office of Health and Environmental Assessment, Office of Research and Development, Cincinnati, OH. 1985. In some embodiments, the hydrophobic monomer may be selected from the group consisting of isostearyl (meth)acrylate (ISMA), ethoxylated bisphenol A di(meth)acrylate (BisEMA; EBDMA), stearyl (meth)acrylate, lauryl (meth)acrylate, isodecyl (meth)acrylate, 2-ethylhexyl (meth)acrylate, isobornyl (meth)acrylate and cyclohexyl (meth)acrylate. In some embodiments, a highly branched version of ISMA is employed having two or more, three or more, or four or more branch points, for example, as shown in Scheme IV, FIG. 5.

The term “aliphatic” or “aliphatic group” as used herein means a straight-chain or branched C₁₋₂₀ hydrocarbon chain that is completely saturated or that contains one or more units of unsaturation, or a monocyclic C₃₋₈ hydrocarbon or bicyclic C₈₋₁₂ hydrocarbon that is completely saturated or that contains one or more units of unsaturation, but which is not aromatic (also referred to herein as “carbocycle” or “cycloalkyl”), that has a single point of attachment to the rest of the molecule wherein any individual ring in said bicyclic ring system has 3-7 members. For example, suitable aliphatic groups include, but are not limited to, linear or branched C₁₋₂₀ alkyl, alkenyl, alkynyl groups and hybrids thereof such as (cycloalkyl)alkyl, (cycloalkenyl)alkyl or (cycloalkyl)alkenyl. For example, aliphatic groups may be C₁₋₂₀, C₂₋₁₂, or C₄₋₈ straight or branched chain alkyl.

The terms “alkoxy,” “hydroxyalkyl,” “alkoxyalkyl” and “alkoxycarbonyl,” used alone or as part of a larger moiety include both straight and branched chains containing one to twelve carbon atoms. The alkoxyalkyl may be, for example, a polyethylene ether or polypropylene ether.

The terms “alkenyl” and “alkynyl” used alone or as part of a larger moiety shall include both straight and branched chains containing two to twelve carbon atoms having at least one double bond or triple bond, respectively.

The term “heteroatom” means nitrogen, oxygen, or sulfur and includes any oxidized form of nitrogen and sulfur, and the quaternized form of any basic nitrogen.

The term “aryl” used alone or in combination with other terms, refers to monocyclic, bicyclic or tricyclic carbocyclic ring systems having a total of five to fourteen ring members, wherein at least one ring in the system is aromatic and wherein each ring in the system contains 3 to 8 ring members. The term “aryl” may be used interchangeably with the term “aryl ring”. The term “aralkyl” refers to an alkyl group substituted by an aryl. The term “aralkoxy” refers to an alkoxy group substituted by an aryl.

The term “(meth)acrylate” when used in a chemical name is intended to encompass both methacrylate and acrylate chemical structures.

Some synthetic polymers may have a distribution of molecular weights (MW, grams/mole). Polydispersity describes a polymer consisting of molecules with a variety of chain lengths and molecular weights. The width of a polymer's molecular weight distribution is estimated by calculating its polydispersity, Mw/Mn. The closer this approaches a value of 1, the narrower is the polymer's molecular weight distribution.

The weight-average molecular weight (Mw) is the average molecular weight of a polydisperse polymer sample, averaged to give higher statistical weight to larger molecules; calculated as Mw=SUM (Mi² Ni)/SUM (Mi Ni), where Ni is the number of molecules of molecular weight Mi. One technique used to measure molecular weights of polymers is light scattering. A light shining through a very dilute solution of a polymer is scattered by the polymer molecules. The scattering intensity at any given angle is a function of the second power of the molecular weight.

Consequently, because of this “square” function, large molecules will contribute much more to the molecular weight that we calculate than small molecules.

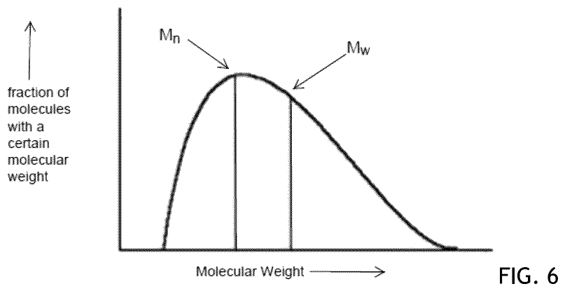

The number-average molecular weight (Mn) is the average molecular weight of a polydisperse polymer sample, averaged to give equal statistical weight to each molecule; calculated as Mn=SUM (Mi Ni)/SUM (Ni), where Ni is the number of molecules of molecular weight Mi. Relationship of Mn and Mw is shown in FIG. 6.

Monomers

One problem to be solved was to develop a new polymerizable material amenable to 3D printing for use in dental applications and other applications, and that has greater strength and toughness than dental composite restoratives while also offering exceptional clinical performance and durability. The design of strong intermolecular hydrogen bonding of the copolymers of PCL urethane (meth)acrylate monomers combined with acidic monomers gives a unique resin system with uniquely high mechanical strength properties. In some embodiments, the improved mechanical properties are retained in the presence of water.

In some embodiments, the disclosure provides a polymerizable resin composition comprising a PCL urethane (meth)acrylate monomer comprising two or more (meth)acylate groups and two or more urethane groups capable of intermolecular hydrogen bonding.

In some embodiments, the disclosure provides a polymerizable resin composition comprising a PCL urethane (meth)acrylate monomer, and an acidic monomer.

In some embodiments, the disclosure provides a polymerizable resin composition comprising a PCL urethane (meth)acrylate monomer, an acidic monomer and one or more hydrophobic monomers.

In some embodiments, the disclosure provides a composition comprising a PCL urethane (meth)acrylate monomer, an acidic monomer, an initiator, and optionally one or more hydrophobic monomers.

PCL Urethane (Meth)Acrylate Monomers

The disclosure provides novel PCL urethane (meth)acrylate monomers. The PCL urethane (meth)acrylate monomers may comprise at least one (meth)acrylate moiety, at least one urethane moiety and at least one PCL moiety. The PCL urethane (meth)acrylate monomers may comprise a chemical structure according to Formula (I):

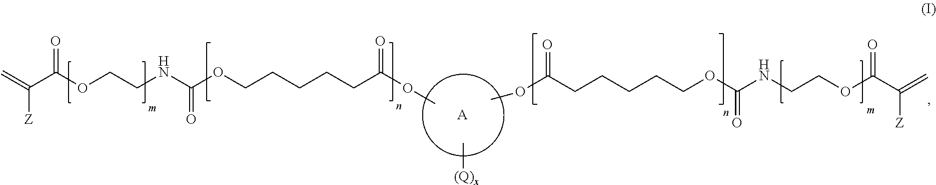

wherein A=aliphatic, aromatic, alkoxyalkyl, alkoxy, hydroxyalkyl, or alkoxycarbonyl core structure; independently each n=0-12, wherein at least one n≠0); x=0-6; each Z=CH₃ or H; each m=1-5; and Q=OH or OR,
where R=

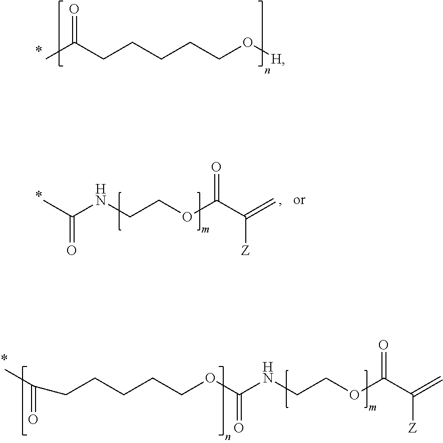

In some embodiments, average n=0.3-12. In some embodiments, A=straight or branched chain C₂₋₁₂ aliphatic, alkylalkoxy. In some embodiments, avg. n=1-5; x=0-3, m=1-3. In some embodiments, n=1-5; x=0-3, m=1-3. In some specific embodiments, A=C₆ branched alkyl or diethylether.

The disclosure provides novel PCL urethane (meth)acrylate monomers according to Formula (Ia) or (Ib).

In some embodiments, a PCL triurethane tri(meth)acrylate monomer is provided according to Formula (Ia), wherein each m is independently=1-5, 1-3, 1-2, 1, 2, 3, 4, 5; each Z=CH₃ or H; and each n is independently=1-12, 1-5, 1-2. In one specific embodiment, a PCL₃₀₀ triol + IEM monomer is provided according to Formula (Ia), wherein each n is independently=1-2, and each m=1. In another specific embodiment, a PCL₃₀₀ triol + IEMₑₓₜ momomer is provided according to Formula (Ia) each n is independently=1-2, and each m=2.

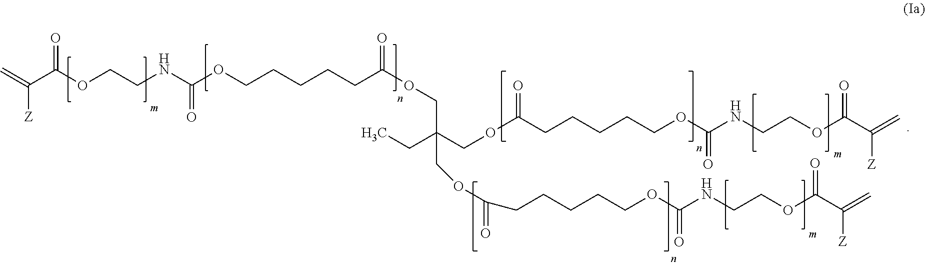

In some embodiments, the present disclosure provides a PCL diurethane di(meth)acrylate monomer according to Formula (Ib),

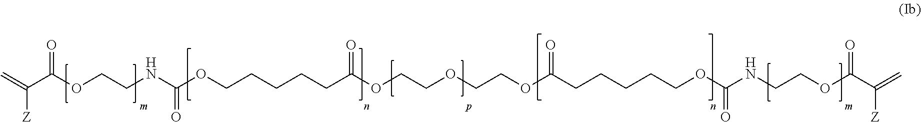

wherein each m is independently=1-5, 1-3, 1-2, 1, 2, 3, 4, 5; each n is independently=1-12, 6-10, 1-5, or 1-2; each Z=CH₃ or H; and p=0-12, 1-10, or 1-6. In a specific embodiment, a PCL₅₃₀ diol + IEM monomer is provided wherein each n is independently=1-2, each m=1. In another specific embodiment, a PCL₅₃₀ diol + IEMₑₓₜ monomer is provided wherein each n is independently=1-2, each m=2. In a specific embodiment, a PCL₂₀₀₀ diol + IEM monomer is provided wherein each n is independently=6-10, each m=1. The PCL diurethane dimethacrylates of Formula (Ib) (FIG. 3) may be obtained by reaction of two molar equivalents of IEM (3, m=1) or IEMext (3, m=2), with each PCL diol 5, wherein independently each n=0 to 12, 0-8, 1-8, 1-5, 1-2, 1, 2, 3, 4, 5, 6, 7, 8, 9, 10, or 12, wherein at least one n≠0; and p=0-12, 1 to 10, or 1 to 6, 1, 2, 3, 4, 5, 6, 7, 8, 9, 10, 11, or 12.

In some embodiments, the present disclosure provides a PCL tetraurethane di(meth)acrylate monomer according to Formula (IIa),

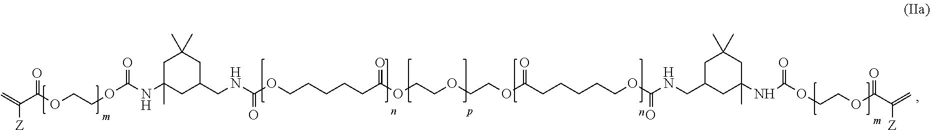

wherein n=1 to 10, 1, 2, 3, 4, 5, 6, 7, 8, 9, or 10; m=1 to 5, or 1, 2, 3, 4, or 5; p=0 to 12, or 0, 1, 2, 3, 4, 5, 6, 7, 8, 9, 10, 11, or 12; and z=H or CH₃; optionally wherein n=1 to 5, m=1 to 3, p=1 to 6.

In some embodiments, the present disclosure provides a PCL tetraurethane di(meth)acrylate monomer according to Formula (IIb),

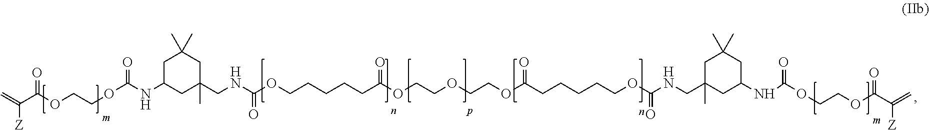

wherein n=1 to 10, 1, 2, 3, 4, 5, 6, 7, 8, 9, or 10; m=1 to 5, or 1, 2, 3, 4, or 5; p=0 to 12, or 0, 1, 2, 3, 4, 5, 6, 7, 8, 9, 10, 11, or 12; and z=H or CH₃; optionally wherein n=1 to 5, m=1 to 3, p=1 to 6.

Acidic Monomers

In some embodiments, acidic monomer is selected from methacrylic acid (MAA), or another acidic monomer, for example as shown in FIG. 4. Other acidic monomers can be used in place of MAA, but increased spacing between the acidic and polymerizable functional groups might affect the high strength potential of the copolymers with PCL monomers. In some embodiments, the polymerizable resin composition comprises an acidic monomer selected from methacrylic acid and acrylic acid or other —COOH or —OP(═O)(OH)₂ containing monomers. In some embodiments, the resin compositions comprise MAA monomer. In some embodiments, the compositions do not comprise MAA. The urethane group of the PCL urethane (meth)acrylate monomer and the acidic group of the acidic monomer are capable of intermolecular hydrogen bonding. Exemplary acidic monomers include methacrylic acid (MAA), acrylic acid, itaconic acid, mono-2-(methacryloyloxy)ethyl maleate, pyromellitic dianhydride glycerol dimethacrylate, 2-carboxyethyl acrylate, 2-carboxyethyl acrylate oligomer, mono-2-(methacryloyloxy)ethyl succinate, glycerol dimethacrylate/succinate adduct, 1,3-glycerol dimethacrylate/maleate adduct, bis[2-(methacryloyloxy) ethyl] phosphate, and ethylene glycol methacrylate phosphate.

Hydrophobic Monomers

The disclosure provides polymerizable resin compositions comprising one or more hydrophobic monomers comprising one or more acrylate or methacrylate groups. In some embodiments the hydrophobic monomer is selected from one or more of Isostearyl methacrylate (ISMA), Ethoxylated bisphenol A dimethacrylate (BisEMA; EBDMA), stearyl methacrylate, lauryl methacrylate, isodecyl methacrylate, 2-ethylhexyl methacrylate and cyclohexyl methacrylate.

For example, the hydrophobic monomer may be used to improve the conversion of the final cured polymer, thus improving the hardness (as measured by the Vicker's hardness) and stiffness (as measured by the Young's modulus). It also assists in making the cured polymer hydrophobic and thus counters the hydrophilic nature of MAA.

In a specific embodiment, the hydrophobic monomer is ISMA. The ISMA is commercially available but is not typically used in dental materials applications. The ISMA improves the conversion of the final cured polymer, thus improving the hardness (as measured by the Vicker's hardness) and stiffness (as measured by the Young's modulus). It also assists in making the cured polymer hydrophobic and thus counters the hydrophilic nature of MAA.

As used herein, the PCL urethane (meth)acrylate monomers and the acidic monomers are considered to be hydrogen-bond forming monomers. In some embodiments, the disclosure provides polymerizable resin compositions comprising hydrogen-bond forming monomers (PCL urethane (meth)acrylate monomers and acidic monomers) and hydrophobic monomers, wherein the weight ratio of hydrogen-bond forming monomers to hydrophobic monomers is from 99:1 to 50:50; 90:10 to 60:40; or 85:15 to 75:25, or about 80:20.

The ISMA provides extreme hydrophobic character that also may promote both high conversion and stain resistance. The highly branched ISMA structure also contributes sub-nanometer sites with greater localized mobility that serve to absorb mechanical energy and thereby enhance toughness in the copolymer. In some aspects, the use of the branched ISMA structure rather than a linear stearyl methacrylate is preferred since the latter is more prone to the formation of phase-separated semi-crystalline domains that could negatively affect the translucency of the final polymer.

In some embodiments, the hydrophobic monomer may be a hydrophobic cross-linker such as Ethoxylated bisphenol A dimethacrylate (BisEMA; EBDMA). In some embodiments, the hydrophobic monomer is a combination of Ethoxylated bisphenol A dimethacrylate (BisEMA; EBDMA) and Isostearyl methacrylate (ISMA). In some embodiments, the hydrophobic monomer is Isostearyl methacrylate (ISMA). In some embodiments, a cross linking monomer such as BisEMA is employed.

Fillers

The ability to widely alter the filler loading without sacrifice to the strength and toughness makes the present disclosure well suited for use as a denture tooth material. The overall filler content also allows the modulus and surface hardness of the polymerized composite material to be altered with higher filler contents (especially when the OX50 nanofiller is included) leading to reduced wear rates. The filler content also aids in control of the coefficient of thermal expansion and is directly related to the x-ray opacity of the composite material.

There is no restriction in the type of filler that can be utilized in the filled compositions of the disclosure. In some embodiments, the filler material is selected from one or more of quartz, strontium, zirconium, and ytterbium-based particulate fillers. In some embodiments, the filler is selected from Ba glass, fumed silica, and ytterbium fluoride. In some embodiments, the filler phase is prepared from a bimodal mixture of barium glass with (Ba glass) and fumed silica (OX50). In some embodiments, the filler is ytterbium fluoride. In some embodiments, the filler employed in the filled polymer is Ba glass/OX50. In some embodiments, the filler is Ba glass/OX50/Yb. In some embodiments a mass ratio of 9:1 Ba glss/OX50 is employed. In some embodiments, the filler phase contains a silane methacrylate surface treatment (gamma-methacryloxypropyltrimethoxysilane. In some embodiments, the filler phase is prepared from a bimodal mixture of barium glass with methacrylate silane surface treatment (Ba glass) and fumed silica with methacrylate silane surface treatment (OX50). In some embodiments, the filler is ytterbium (Yb) glass with methacrylate silane surface treatment. In some embodiments, the surfaces of the filler are coated with a surfactant. In some embodiments, an OX50 nanofiller is employed. In some embodiments, filler is added between about 40 to 90 wt %, 50 to 85 wt %; and 70 to 80 wt % with respect to the overall composite composition. In some embodiments one or more fillers is present at 75 wt % of higher compared to the weight of the filled composition. In some embodiments, one or more fillers is used at 85 wt % or higher compared to the weight of the filled composition.

The filler provides a dough-like consistency for the composite material in the monomeric state. The paste consistency can be raised or reduced depending on the choice of filler, ratio of the fillers and the filler loading level used. The optical properties of the paste and the final polymerized composite material depend on the degree of mismatch between the refractive indices of the fillers and the resin phase as well as the degree of conversion achieved during the polymerization process. A high degree of conversion (preferably 95% or higher) is desirable to maximize the mechanical properties of the polymeric material while minimizing or avoiding any leachable free monomer.

Initiators

The polymerization of the monomers may be initiated by any suitable method of generating free-radicals such as by thermally induced decomposition of a thermal initiator such as an azo compound, peroxide or peroxyester. Alternatively, redox initiation or photo-initiation can be used to generate the reactive free radicals. Therefore the polymerization mixture also preferably contains a polymerization initiator which may be any of those known and conventionally used in free-radical polymerization reactions, e.g. azo initiators such as 2,2′azobis(isobutyronitrile) (AIBN), azobis(2-methylbutyronitrile), azobis(2,4-dimethylvaleronitrile), 4,4-azobis(4-cyanovaleric acid), 1,1′-azobis(cyclohexanecarbonitrile); peroxides such as benzoyl peroxide, dilauroyl peroxide, tert-butyl peroxyneodecanoate, dibenzoyl peroxide, 2,2-bis (tert-butylperoxy)butane, 1,1-bis(tert-butylperoxy)cyclohexane, 2,5-bis (tert-butylperoxy)-2,5- dimethylhexane, 2,5-bis(tert-Butylperoxy)-2,5-dimethyl-3-hexyne, bis(1-(tert-butylperoxy)-1- methylethyl)benzene, 1,1-bis(tert-butylperoxy)-3,3,5-trimethylcyclohexane, tert-butyl hydroperoxide, tert-butyl peracetate, tert-butyl peroxide, tert-butylperoxy isopropyl carbonate, cyclohexanone peroxide, dicumyl peroxide, lauroyl peroxide, 2,4- pentanedione peroxide, peracetic acid, cumyl peroxide, tert-butyl peroxy-2-ethyl hexanoate, tert-butyl peroxy diethyl acetate, tert-amyl peroxybenzoate, and tert-butyl peroxy benzoate. In some embodiments, the thermal initiator is benzoyl peroxide (BPO). The BPO has been effectively used at concentrations between 0.85 and 2 wt % relative to the resin phase. The preferred concentration is 1.35-1.85 wt %. In some embodiments, the thermal initiator is AIBN.

In another aspect, the initiator is a redox (reduction-oxidation) pair of initiators. Redox initiator systems use both a primary initiator and a chemical reducing agent. Several types of redox initiator pairs are known such as persulfite-bisulfite, persulfate-thiosulfate, persulfate-formaldehyde sulfoxylate, peroxide-formaldehyde sulfoxylate, peroxide-metallic ion (reduced), persulfate-metallic ion (reduced), benzoyl peroxide-benzene phosphinic acid, and benzoyl peroxide-amine wherein the amine acts as the reducing agent. The redox pair may be selected from any known redox pair such as a combination of benzoyl peroxide and dimethyl-p-toluidine, AMPS (ammonium persulfate) and TEMED (tetramethyl ethylene diamine), sulfur dioxide and tert-butyl hydroperoxide, potassium persulfate and acetone sodium bisulfate. In a specific aspect, the redox initiator pair is 1 wt % benzoyl peroxide with 1.5 wt % dimethyl-p-toluidine amine coinitiator.

In some embodiments, the initiator is a photoinitiator. The photoinitiator can be selected from one or more known photoinitiators. For example, the initiator can be selected from one or more of an alpha-hydroxyketone, an acyl phosphine oxide, a benzoyl peroxide with or without an amine co-initiator. Any known photoinitiator, or combination of one or more photoinitiators can be employed. For example, the photoinitiator can be selected from one or more acyl phosphine oxides such as BAPO (bis-acylphosphine oxide), phenyl-bis(2,4,6-trimethylbenzoyl)phosphine oxide, TPO (Diphenyl(2,4,6-trimethylbenzoyl)phosphine oxide), bis-trimethoxybenzoyl-phenylphosphine oxide, TPO-L, ethyl phenyl(2,4,6-trimethylbenzoyl) phosphinate, or MAPO (tris[1-(2-methyl)aziridinyl]phosphine oxide. Other photoinitiators may be employed alone or in combination including, but not limited to, DMPA (2,2-dimethoxy-2-phenylacetophenone), BDK (benzil dimethylketal), CPK (cyclohexylphenylketone), HDMAP (2-hydroxy-2-methyl-1-phenyl propanone), ITX (isopropylthioxanthrone), HMPP (hydroxyethyl-substituted alpha-hydroxyketone), MMMP (2-methyl-4′-(methylthio)-2-morpholinopropiophenone), BDMB (2-benzil-2-dimethylamino-1-(4-morpholinophenyl)-butanone-1), BP (Benzophenone), TPMK (methylthiophenyl- morpholinoketone), 4-Methylbenzophenone, 2-Methylbenzophenone, 1-Hydroxy cyclohexyl phenyl ketone, 2-Benzyl-2-(dimethylamino)-1-[4-(4-morpholinyl) phenyl]-1-butanone, Diphenyl Iodonium Hexafluorophosphate, Bis (p-tolyl) iodonium hexafluorophosphate, 2-Methyl-1-[4-(methylthio) phenyl]-2-morpholinopropanone-1, 2-Hydroxy-2-methyl-phenyl-propan-1-one, 1,7-bis(9-acridinyl)heptane, 2-Hydroxy-4′-hydroxyethoxy-2-methylpropiophenone, 2,2′-Bis(O-chlorophenyl-4,4′,5,′-tetraphenyl-1,2′-diimidazole, 9-Phenylacridine, N-phenylglycine, 2-(4-methoxyphenyl-4,6-bis (trichloromethyl)-1,3,5-triazine, P-toluene sulfonylamine, Tris-(4-dimethylaminophenyl)methane, Tribromo methyl phenyl sulfone, 2,4-Bis(trichloromethyl)-6-(p-methoxy)styryl-s-triazine, 2,4-Bis (trichloromethyl)-6-(3,4-dimethoxy)styryl-s-triazine, 4-(2-aminoethoxy)methyl benzophenone, 4-(2-hydroxyethoxy)methyl benzophenone, 2-Isopropylthioxanthone, 4-Isopropylthioxanthone, 4-Hydroxy benzophenone, 4-Methyl acetophenone, 4-(4-Methylphenylthiophenyl)-phenylmethanone, dimethoxyphenylacetophenone, camphorquinone, 1-Chloro-4-propoxythioxanthone, 2-Chlorothioxanthone, 2,2-Diethoxyacetophenone, 2,4-Diethylthioxanthone, 2-Dimethyl-aminoethylbenzoate, 2-Ethylhexyl-4-dimethylaminobenzoate, Ethyl-4-(dimethylamino) benzoate, 2-Isopropylthioxanthone, Methyl o-benzoyl benzoate, Methyl phenyl glyoxylate, 4,4′-Bis(diethylamino) benzophenone, 4-Phenylbenzophenone,2,4,6- and Ethyl (2,4,6-trimethylbenzoyl) phenylphosphinate. In a specific aspect the initiator is BAPO bis-acyl phosphine oxide commercially available, for example, bis(2,4,6-trimethylbenzoyl)-phenylphosphineoxide (Omnirad 819, formerly known as Irgacure 819) from IGM Resins B.V., The Netherlands. The photoinitiator may be phenylbis(2,4,6-trimethylbenzoyl) phosphine oxide (Lucirin® TPO, BASF). The photoinitiator may be 1-hydroxy-cyclohexylphenyl ketone (OMNIRAD 184D, formerly Irgacure 184D) or 2-hydroxyl-2-methylpropiophenone (OMNIRAD 1173, formerly Irgacure 1173).

In some embodiments, the initiator is not camphorquinone. In some embodiments, the initiator is not ethyl O-dimethylaminobenzoate. In some embodiments, the initiator is not 4-N,N′-dimethylaminobenzoate.

The polymerization photoinitiators are used in amounts effective to initiate polymerization in the presence of the curing radiation, typically about 0.01 to about 10 wt %, about 0.05 to about 7 wt %, about 0.1 to about 5 wt %, about 0.5 to 2 wt %, or about 1.2 to 1.9 wt % based on the total weight of the composition.

The photoinitiator composition can optionally further contain a coinitiator for example, EHA (2-ethyl hexylacrylate) or an amine coinitiator such as, for example, ethyl-4-(dimethylamino)benzoate, 2- ethylhexyl dimethylaminobenzoate, dimethylaminoethyl (meth)acrylate, or the like. Reactive amine polymerization coinitiators can be used, such as the coinitiator CN386 (a reactive amine adduct of tripropylene glycol diacrylate), commercially available from Sartomer, Darocure EHA, e.g., commercially available from Ciba, and the like. The coinitiator can be present in the composition in an amount of about 0.25 to about 20 wt %, specifically about 1 to about 10 wt %, and more specifically about 1 to about 5 wt %, based on the total weight of the composition.

Chain Transfer Agents

In some embodiments, a chain transfer agent may be employed. The chain transfer agent may be chosen from a range of thiol compounds including monofunctional and multifunctional thiols. Monofunctional thiols include, but are not limited to, propyl mercaptan, butyl mercaptan, hexyl mercaptan, octyl mercaptan, dodecyl mercaptan (docecanethiol, DDT), thioglycolic acid, methylbenzenethiol, dodecanethiol, mercaptopropionic acid, alkyl thioglycolates e.g. 2-ethyl hexyl thioglycolate or octylthioglycolate, mercaptoethanol, mercaptoundecanoic acid, thiolactic acid, thiobutyric acid. Multifunctional thiols include trifunctional compounds such as trimethylol propane tris(3-mercaptopropionate), tetrafunctional compounds such as pentaerythritol tetra(3-mercaptopropionate), pentaerythritol tetrathioglycolate, pentaerythritol tetrathiolactate, pentaerythritol tetrathiobutyrate; hexafunctional compounds such as dipentaerythritol hexa(3-mercaptopropionate), dipentaerythritol hexathioglycolate; octafunctional thiols such as tripentaerythritol octa(3-mercaptopropionate), tripentaerythritol octathioglycolate. The use of multifunctional thiols is a useful way to increase the degree of branching in the polymer. A difunctional chain transfer agent contains at least one thiol and at least one hydroxyl group. Examples of difunctional chain transfer agents include mercaptoethanol, mercaptopropanol, 3-mercapto-2-butanol, 2-mercapto-3-butanol, 3-mercapto-2-methyl-butan-1-ol, 3-mercapto-3-methyl-hexan-1-ol and 3-mercaptohexanol. Optionally, the chain transfer agent may comprise a mixture of more than one type of compound. In some embodiments, the chain transfer agent is docecanethiol. The amount of chain transfer agent present may be up to 50 wt % of the total initial monomer concentration. In a first embodiment, the amount of chain transfer agent present is 0.1-20% w/w, e.g. 0.5-10% w/w based on total monomer in the monomer mixture. The branched polymer is made using an appropriate amount of chain transfer agent to prevent the formation of a substantial amount of insoluble cross-linked polymer.

Compositions

The compositions of the disclosure are suitable for 3D printing or molding of dental prosthetic devices and non-prosthetic appliances, denture bases and teeth, temporary restorations, splints, impression trays, surgical guides, casts, try-in set-ups, stents, and aligners. The compositions provided herein are also suitable for 3D printing of other devices and parts in the medical, automotive, communication, computer, electronics, and aeronautical industries.

Compositions are provided suitable for 3D printing comprising a PCL urethane (meth)acrylate monomer according to the disclosure. Homopolymers or copolymers may be formed from resin compositions provided herein. In some embodiments, a resin composition is provided comprising a PCL urethane (meth)acrylate monomer and an acidic monomer. Addition of the acidic monomer significantly decreases the viscosity of the polymerizable resin composition comprising the PCL urethane (meth)acrylate monomer, as shown in Table III. Following photocure, the copolymers formed from the resin compositions comprising the PCL urethane (meth)acrylate monomer and the acidic monomer exhibit significantly increased flexural strength, flexural modulus and toughness compared to homopolymers formed from PCL urethane (meth)acrylate monomers alone, as shown in Tables IA, IB, IC, IIA, IIB, and discussed herein.

The PCL urethane (meth)acrylate monomer may be a PCL triurethane tri(meth)acrylate monomer and/or a PCL diurethane di(meth)acrylate monomer, and the acidic monomer is methacrylic acid (MAA). The optimal properties are obtained when there is a stoichiometric balance between hydrogen bond accepting groups on a first comonomer and hydrogen bond donor groups on a second comonomer. The PCL urethane (meth)acrylate monomer contains urethane groups that capable of acting as hydrogen bond donors or acceptors. The carboxylic acid group of MAA is capable of acting as a hydrogen bond acceptor (e.g., C═O), or donor (CO₂H) depending on pH of the composition. For example, a PCL diurethane di(meth)acrylate monomer has two urethane groups per molecule capable of forming at least two hydrogen bonds. MAA has a single carboxylic acid group and is capable of forming at least one hydrogen bond. Therefore, for example, a 1:2 molar ratio of PCL diurethane di(meth)acrylate monomer /MAA may be employed to give a urethane:acidic moiety ratio of 1:1. In the present disclosure it has surprisingly been found that a urethane:acidic moiety ratio of 1:1 to 1:10, 1:1 to 1:5, or 1:1 to 1:3 may be employed. For example, the urethane:acidic moiety ratio of 1:1, 1:2, 1:3, 1:4, 1:5, 1:6, 1:7, 1:8, 1:9, 1:10, or any intervening ratio, or higher may be employed.

The polymerization of these materials may be assisted by light, pressure and/or heat to maximize their conversion and properties.

It should be noted that MAA is not generally considered a suitable comonomer for dentistry in general because of the at least mildly unpleasant odor of MAA. As most dental materials are first and foremost used in direct fill situations (meaning the material is placed in the patient's mouth in the monomeric state and cured in place), this explains why MAA has been underutilized as a dental material.

However, the present research indicates that MAA can appropriately be applied in indirect dental materials which are lab cured materials that are then used as cemented inlays/onlays and crowns as well as denture teeth and aligners. In these applications, the drawback of odor is no longer a factor.

Methods of Making

The present disclosure provides polycaprolactone (PCL) urethane (meth)acrylate monomers comprising at least one or at least two urethane moieties, at least two PCL moieties, and at least two (meth)acrylate moieties. FIG. 1 shows an exemplary synthetic chemical Scheme IA for production of a generic polycaprolactone (PCL) polyurethane (meth)acrylate monomer according to Formula (I). Starting polycaprolactone (PCL) polyols may be purchased commercially or may be prepared by any suitable method known in the art.

The data provided herein include three commercially polycaprolactone (PCL) diol and triol starting materials used to produce the PCL urethane (meth)acrylate monomers of the present disclosure. These PCL monomers according to Formulas (I), (Ia), (Ib) and other variations may be utilized as novel PCL urethane poly (meth)acrylate monomers alone or in combination with other monomers for preparing copolymer resins according to the disclosure.

Methods for making PCL urethane (meth)acrylate monomers are provided. A starting polyol compound (1) having a core structure A, where A=heteroatom substituted or unsubstituted aliphatic or aromatic core structure, and x=0-6, 0-3, 0-2, 0, 1, 2, 3, 4, 5, 6, 7, 8, 9, 10, 11, or 12, may be treated with caprolactone and a catalyst to provide a polycaprolactone (PCL) polyol (2) as shown in FIG. 1. The core structure A in (1) may be a heteroatom substituted or unsubstituted aliphatic or aromatic core structure, having two or more hydroxyl group substituents. Alternatively a starting aliphatic or aromatic core A-(R²-NH2)₂₋₈ may be employed with the caprolactone or PCL, wherein R²=heteroatom substituted or unsubstituted C₁₋₁₂ aliphatic, C₁₋₆ aliphatic.

The starting polyol (1) (x=0-6, or 0-3)(FIG. 1), may be reacted with caprolactone, for example by ring opening polymerization, or polycondensation of 6-hydroxycaproic acid using, e.g., a lipase enzyme, to provide an intermediate 2, where R=polycaprolactone (PCL) polyol and independently each n=0-12, where at least one n≠0. In some embodiments, average n=0.3-12, 0.5-10, 1-6, 1-3, 1-2. Ring opening polymerization (ROP) may be performed by any suitable method known in the art, for example, by the methods of Labet and Theilemans, Chem. Soc. Rev., 2009, 38, 3484-3504.

Various ROP catalysts or initiators may be employed to provide the PCL polyol intermediate, 2, from starting polyol, 1, and caprolactone as shown in FIG. 1; in some embodiments, A=aliphatic or aromatic core, x=0-6, R=-[(C═O)(CH₂)₅O]ₙ-H, R′=R or H; n=1-12.

The catalyst for preparing the polycaprolactone (PCL) polyol intermediate (2) from the reaction of (1) with caprolactone as shown in FIG. 1 may be any suitable catalyst. For example, the catalyst may be a ring opening polymerization (ROP) catalyst such as a metal-based catalyst, an enzyme, or an organic compound, for example, according to Labet et al., Chem. Soc. Rev., 2009, 38, 3484-3504, which is incorporated herein by reference. Metal-based catalysts may include alkali-based catalysts (e.g., lithium diisopropylamide (LDA), phenyl lithium, cyclopentadienyl sodium, tert-butoxyl potassium); alkaline earth based catalysts (alkyl containing magnesium complexes, magnesium alkoxide complexes, magnesium aryloxide, calcium based systems)calcium ammoniate, strontium diisopropoxide, strontium ammoniate isopropoxide); aluminum or tin based catalysts (aluminum (III) triflate, diethyl aluminum methoxide, diethylaluminum allyl oxide, diisobutylaluminum methoxidealuminum (III) isopropoxide, stannous(II) ethylhexanoate, tin(II) octoate); transition metal based catalysts (e.g., zinc mono- or dialkoxides, zirconium(IV) acetylacetonate, iron (III) alkoxides); rare earth metal based catalysts (e.g., scandium triflate, yttrium isopropoxide,samarium (II) aryloxides, etc.). The metal-based compound catalyst may be, for example, tin(II) trifluoromethanesulfonate (tin (II) triflate, Sn(OTf)2, CAS No. 62086-04-8, Sigma-Aldrich); scandium (III) trifluoromethane sulfonate (Sc(OTf)3; CAS No: 144026-79-9); or tin (II) 2-ethylhexanoate (Sn(Oct)2; CAS No: 301-10-0). Ring opening polymerization (ROP) may be performed using enzymes such as, e.g., lipase (NOVOZYM® 435), or esterase. ROP may be catalyzed by organic compounds and inorganic acids (e.g., 1,5,7-triazabicyclo[4.4.0]dec-5-ene (TBD), N-methyl-1,5,7-triazabicyclo[4.4.0]dec-1-ene (MTBD), 1,8-diazabicyclo[5.4.0]-undec-7-ene (DBU), optionally with co-catalysis by thiourea). Optional suitable solvents may be employed such as, e.g., dioxane, tetrahydrofuran (THF), toluene; or supercritical CO_{2.}

Varied stoichiometry and techniques may be employed to control the average chain length of the PCL (or other) spacer groups in the final monomer structure.

Intermediate 2 comprising polycaprolactone(PCL) polyol moieties is treated with an isocyanatoethyl (meth) acrylate (IEM) 3 to obtain the PCL polyurethane (meth)acrylate monomers according to Formula (I), as shown in FIG. 1.

In some embodiments, PCL polyol (2) comprises wherein independently each n=0-12 where at least one n is not equal to 0, 1-12, 1-5, 1-2, 1, 2, 3, 4, 5, 6, 7, 8, 9, 10, 11, or 12. The PCL polyol (2) may be treated with an isocyanato (meth)acrylate (I), wherein m=1-5, 1-3, 1-2, 1, 2, 3, 4, or 5, Z=CH₃ or H, to provide the PCL urethane (meth)acrylate monomer according to Formula (I) for use according to the present disclosure.

The present disclosure provides copolymer compositions comprising an acidic monomer with a PCL urethane (meth)acrylate monomers according to Formula (I).

Remarkably it is the copolymers prepared from the inclusion of the acidic monomer with the PCL urethane (meth)acrylate monomers according to Formula (I) that greatly improves the mechanical property and toughness when compared to the homopolymers prepared from PCL urethane (meth)acrylate monomers alone.

The acidic monomer for use according to the disclosure comprises a (meth)acrylate moiety and a carboxylic acid or phosphoric acid moiety. For example, the acidic monomer may be methacrylic acid (MAA), acrylic acid, itaconic acid, mono-2-(methacryloyloxy) ethyl maleate, pyromellitic dianhydride glycerol dimethacrylate, 2-carboxyethyl acrylate, 2-carboxyethyl acrylate oligomer, mono-2-(methacryloyloxy) ethyl succinate, glycerol dimethacrylate/succinate adduct, 1,3-glycerol dimethacrylate/maleate adduct, bis[2-(methacryloyloxy)ethyl] phosphate, or ethylene glycol methacrylate phosphate, as shown in FIG. 4.

The disclosure provides compositions comprising PCL urethane (meth)acrylate monomers of Formula (I) and an acidic monomer in a stoichiometric ratio of urethane moiety to acidic moiety from the acidic monomer of from about 1:1 to about 1:15, 1:1 to 1:10, 1:1 to about 1:5, 1:1 to about 1:3, from about 1:2 to about 1:10, from about 1:3 to about 1:5, or about 1:1, about 1:2, about 1:3, about 1:5, or about 1:10.

The copolymers prepared from compositions according to the disclosure comprising an acidic monomer and a PCL urethane (meth)acrylate monomers according to Formula (I) exhibit greatly improved mechanical property and toughness when compared to the homopolymers prepared from PCL urethane (meth)acrylate monomers alone.

The increased mechanical properties and toughness of copolymers prepared from compositions according to the disclosure is illustrated in Table IA.1-3.b-c where inclusion of MAA to the PCL triurethane tri (meth)acrylate monomer according to Formula (Ia) prepared from PCL300 triol + IEM in a 1:1 stoichiometric molar ratio of urethane moiety to acidic moiety from acidic monomer results in increased flexural mechanical properties compared to PCL monomer alone, including significantly increased toughness (1045+/−505 J/m³ vs. 423+/−104 J/m³), increased flexural strength (143.5+/−14.3 MPa vs. 97.6+/−13.3 MPa), and increased flexural modulus (2.67+/−0.23 GPa vs. 2.05+/−0.20 GPa). An increase in tensile mechanical properties with addition of MAA to PCL triurethane tri(meth)acrylate monomer according to Formula (Ia) is also seen as shown in Table II.A.1-3.a-b.

The increased mechanical properties and toughness of copolymers prepared from compositions according to the disclosure is illustrated in Table IB.6-8.f-g where inclusion of MAA to the PCL diurethane di(meth)acrylate monomer according to Formula (Ib) prepared from PCL530 diol +IEM in a 1:1 stoichiometric molar ratio of urethane moiety to acidic monomer results in increased flexural mechanical properties compared to PCL monomer alone, including significantly increased toughness (667+/−116 J/m³ vs. 78+/−13 J/m³), increased flexural strength (59.6+/−0.4 MPa vs. 4.7+/−0.6 MPa), and increased flexural modulus (1.2+/−0.09 GPa vs. 0.037+/−0.003 GPa). An increase in tensile mechanical properties with addition of MAA to PCL diurethane di (meth)acrylate monomer according to Formula (Ib) is also seen as shown in Table IIB.5-7.e-f.

Inclusion of the acidic monomer also results in a significant decrease in resin viscosity compared to the PCL urethane (meth)acrylate monomers alone. This effect is illustrated in Table III.1-2.a, where a resin comprising PCL diurethane di(meth)acrylate monomer according to Formula (Ib) prepared from PCL530 diol + IEM alone exhibits a viscosity of 1226+/−176 mPa.s compared to a resin comprising a PCL urethane (meth)acrylate monomer prepared from PCL530 diol + IEM +MAA exhibiting a significantly decreased viscosity of 206+/−8 mPa.s at ambient temperature. This effect on reducing viscosity is even more pronounced as shown in Table III.4-5.a where a PCL triurethane tri (meth)acrylate monomer according to Formula (Ia) prepared from PCL300 triol + IEM exhibits a resin viscosity of 17,695+/−1628 mPa.s compared to a resin composition comprising the PCL triurethane tri(meth)acrylate monomer prepared from PCL300 triol + IEM +MAA, exhibits a significant and remarkable reduction in viscosity to 59+/−2 mPa.s.

One surprising aspect of the present disclosure is that the use of greater than stoichiometric molar amounts of the acidic monomers compared to urethane moieties of the PCL urethane (meth)acrylate monomers result in a further significant escalating increase in flexural strength, flexural modulus, and toughness for 1:3, 1:5, and 1:10 ratios compared to the 1:1 stoichiometric urethane moiety/acidic monomer molar ratio. This effect is illustrated in a comparison of Table IB.6-8.g-i and Table IC.11-13.1-n. The increase in mechanical properties goes well beyond the stoichiometric balance between urethane and acid functionalities, which is one important aspect of the present disclosure. In contrast, a composition comprising non-PCL monomer UDMA and acidic MAA according to U.S. Pat. No. 9,682,018, which is incorporated herein by reference, there was a significant drop in mechanical properties beyond the stoichiometric balance point, so the UDMA/MAA molar ratio was limited to a range of 1:2±20%. Without being bound by theory, an excess of the acidic monomer likely gets involved in interactions with the ester linkages in the PCL segments. Surprisingly, the additional acid does not lead to compromised toughness or brittle behavior in these polymers as it did with UDMA.

The compositions of the disclosure may further comprise a hydrophobic monomer, for example, in order to tailor water uptake and/or wet strength of the copolymers formed therefrom. The ratio of PCL urethane (meth)acrylate monomer urethane moiety to hydrophobic monomer may be from about 10:1 to about 1:10, about 1:1 to about 1:10, about 1:2 to about 1:10, about 1:3 to about 1:7, or about 1:5. One such hydrophobic monomer, the highly branched isostearyl methacrylate (ISMA) was employed with compositions of the disclosure. Table IV shows flexural mechanical properties, wherein a composition comprising PCL monomer from PCL530 diol + IEM, MAA(x), and ISMA(y), where x=3, y=5 molar ratio compared to urethane moiety, exhibited further increased mechanical properties and toughness as shown in Table IV.1-3.a (no ISMA) as compared to Table IB.6-8.h (ISMA, y=5). The ISMA significantly increases the strength and modulus of the PCL urethane monomer + MAA resin formulations.

The post-cure process may be an important component of the overall polymer production process, where post-cure can improve strength and toughness, as well as the final level of conversion achieved. Typical post-cure conditions were 80° C. for 1 hour with exposure to both 365 and 405 nm lights. As shown in Table IA.4.a-b, post cure resulted in a significant increase in conversion % from 70.2+/−3.1% without post-cure to 98.2+/−1.1% from PCL urethane (meth)acrylate monomer formed from PCL300 triol + IEM. Flexural strength and flexural modulus also increased with post-cure as shown in Table IA.1-2.a-b. A similar significant increase in conversion is seen when MAA is added to the PCL urethane (meth)acrylate monomer formed from PCL300 triol + IEM from 57.6+/−2.8% without post-cure to 83.6+/−1.8% conversion with post-cure as shown in Table IA.4.c.

End Uses

Dental aligners are provided exhibiting a high degree of strength and toughness, but since they are used in relatively thin cross-section, also exhibiting some flexibility. The disclosure provides polymerizable compositions which may be used for provision of dental aligners exhibiting high strength, and a high degree of recoverable flexibility without fracture or creep, along with optical clarity, and the retention of these properties in the presence of water.

Dentures are prosthetic devices constructed to replace missing teeth, and which are supported by surrounding soft and hard tissues of the oral cavity.

Conventional dentures are removable, however there are many different denture designs, some which rely on bonding or clipping onto teeth or dental implants. There are two main categories of dentures, depending on whether they are used to replace missing teeth on the mandibular arch or the maxillary arch. There are many informal names for dentures such as dental plate, false teeth and falsies.

An important aspect of denture construction is the manufacture of the denture teeth. Denture teeth refers to the teeth of the denture which may be made of a different material than the remainder of the denture. Such denture teeth should be mechanically strong in order to resist breakage during use. The measurement of mechanical strength is well known in the art and any suitable method may be used to characterize a denture tooth material.

In addition to bulk mechanical strength, a dental material's surface hardness is also a factor that will affect relevant properties such as its ability to be polished to a smooth surface and then the related ability to retain its surface finish based on scratch resistance. The surface hardness is evaluated by indentation of the material with a well-defined indenter geometry and force. A Vickers hardness test brings a square pyramidal shaped indenter into contact with the material surface. Under constant load, the indenter sinks into the surface through a yielding deformation of the material until the contact area increases to the point that the actual stress is equivalent to the yield strength of the material. At this equilibrium point, continued penetration stops and after a suitable dwell time, the indenter is removed. The average length of the diagonals created by the indentation is measured and the Vickers hardness (Hv) is calculated by:

Hv=(2F/d²)·sin(136°/2)=1.854F/d² (Equation 1)

where F is the applied force (in kg) and d is the length of the diagonal (in mm).

Another feature of a good denture tooth is its stiffness. The modulus of a material is a measure of its stiffness or resistance to deformation. It is obtained as the slope of the linear portion of the stress-strain curve. Testing involves the application of a limited strain which, up to the proportional limit of the material, induces a purely elastic stress that is completely recoverable when the strain is removed. The material can be tested in either compressive, tensile or flexural modes; however, somewhat different modulus values are obtained depending on the material and the test mode. The modulus also can be obtained from a test of the ultimate strength of a material if only the initial linear region of the stress-strain curve is considered. With stress having units of Pa (based on the force (in N) divided by cross-sectional area (in m²)) and strain having dimensionless units (since a deformation can be measured as a percentage), the unit for modulus is Pa.

In mechanics, the flexural modulus or bending modulus is an intensive property that is computed as the ratio of stress to strain in flexural deformation, or the tendency for a material to resist bending. It is determined from the slope of a stress-strain curve produced by a flexural test (ISO/DIS 4049), and uses units of force per area. For example, in a 3-point test of a rectangular beam behaving as an isotropic linear material, where w and h are the width and height of the beam, I is the second moment of area of the beam's cross-section, L is the distance between the two outer supports, and d is the deflection due to the load F applied at the middle of the beam, the flexural modulus: Ebₑₙd=L³F/4wh³d From elastic beam theory d=L³F/481E and for rectangular beam I=1/12wh³ thus Ebₑₙd=E (Elastic modulus). Ideally, flexural or bending modulus of elasticity is equivalent to the tensile modulus (Young's modulus), or compressive modulus of elasticity.

Flexural strength, also known as modulus of rupture, or bend strength, or transverse rupture strength is a material property, defined as the stress in a material just before it yields in a flexure test. The transverse bending test is most frequently employed, in which a specimen having either a circular or rectangular cross-section is bent until fracture or yielding using a three point flexural test technique. ISO/DIS 4049 technique may be employed in the flexural test. Common measurements are flexural strength and flexural modulus. The test is performed on a Universal Testing Machine equipped with a 3-point bend fixture.

The glass transition, Tg, may be measured by dynamic mechanical analysis, DMA. DMA measures the viscoelastic moduli, storage and loss modulus, damping properties, and tan delta, of materials as they are deformed under a period (sinusoidal) deformation (stress or strain). Tg may be measured using ASTM D7028, Standard Test Method for Class Transition Temperature (DMA Tg) of Polymer Matrix Composites by Dynamic Mechanical Analysis (DMA), ASTM International, West Conshohocken, PA.

Fracture toughness K_{IC} describes the resistance of a material to crack propagation. The higher the value of the critical stress intensity factor (K_{IC}[MPa m]), the better the prognosis for long term clinical behavior of the material. The single-edge notched-beam fracture toughness test, ASTM D5045 may be employed to determine fracture toughness K_{IC.}

In some embodiments, the disclosure provides a polymerizable resin composition suitable for preparation of denture teeth. In some embodiments, the disclosure provides a resin composition comprising at least one PCL urethane (meth)acrylate monomer capable of forming intramolecular hydrogen bonds, an acidic monomer, and optionally one or more hydrophobic monomers and or surfactants.

The disclosure also relates to new and improved denture teeth made using a process and material prepared by polymerization of a composition comprising a resin composition comprising a combination of a mixture of one or more PCL urethane (meth)acrylate monomers and one or more acidic monomers. In some embodiments, the composition may further include one or more hydrophobic monomers and/or surfactants.

In some embodiments, the denture tooth is made with PCL urethane (meth)acrylate/acidic monomer mixture with, or without, a hydrophobic monomer. In some embodiments, when a PCL diurethane di(meth)acrylate monomer and MAA is used, the PCL diurethane di(meth)acrylate monomer/MAA molar ratio may be from 1:2 to 1:20, 1:2 to 1:10; or 1:2 to 1:6; or 1:2 +/−20% in approximately stoichiometric amounts of urethane to carboxylic acid moieties.

A denture tooth or other dental device can be created comprising a polymerized mixture of PCL urethane (meth)acrylate, acidic monomer and optional hydrophobic monomer and at least 75%, at least 60%, or at least 50% by weight of a filler, wherein the denture has a Vickers hardness of at least 75 kgf/(square mm). Further, a denture tooth made of this material will preferably have a greater than 80%, greater than 90% conversion and preferably greater than 95% conversion. It may have a Young's modulus (tensile modulus) of greater than 1, 2, 3, or 4 GPa, or greater, without the use of a filler and so exhibit excellent stiffness properties. If fillers are used, a Young's modulus of greater than 10 GPa and even 15 GPa should be obtainable. This is anticipated to require very high loading of filler, on the order of 75% to as much as 90% or more. However, the material is suitable for such high loadings. As discussed above, a Vickers Hardness of greater than 60 and even 80 kgf/(square mm) has been demonstrated but greater than 100 is anticipated.

Denture Tooth and Device Fabrication

Another aspect of the present disclosure is the fabrication of the denture tooth, aligner, or other device. The denture tooth, aligner or other device may be prepared by any suitable 3D printing technique, or traditional molding methods.

Contemporary dental 3D printing may involve use of near or true ultraviolet radiation (e.g., 405 nm and 385 nm, respectively) in order to fabricate the basic desired from a resin composition comprising a mixture of photo-polymerizable monomers.

After 3D printing, the initial form may be photocured, for example, at 405 nm. After initial photocure, the specimen may optionally be washed with alcohol and subjected to post-cure conditions. Post-cure conditions may comprise additional exposure to near/UV light, as well as optional exposure to heat and or pressure. Post-cure may be employed, for example, to improve physical properties, as well as to reduce leaching of unreacted monomer within the printed item.

A notable component of the fabrication of the denture tooth is a unique step that includes the preparation of the internal surface of the denture tooth with a microadhesion technique (Rocatec-system 3M, Espe, St. Paul, MN) and, in an embodiment, with diatorics (macroadhesive undercuts), along with a bonding agent such as Dentacolor connector (Heraeus Kulzer, Wehrheim, Germany). This bonding agent may be a methacrylate. Information on this bonding agent and others (for a different application) is discussed in an article in the JPD 2001;85:401-8, by Burkhard Wolf. The step may be done at the mold stage after the denture tooth is fabricated or at the stage of denture processing when the flasking procedure allows for isolation of the internal aspects of the teeth. The purpose of these additional steps is to allow bonding of the composite resin denture tooth to the denture matrix with minimal microleakage.

In some embodiments, the denture tooth may be fabricated by use of a polymerizable resin composition comprising a PCL urethane (meth)acrylate monomer, an acidic monomer and one or more hydrophobic monomers.

In some embodiments, the denture tooth may be fabricated by use of a polymerizable resin comprising a PCL urethane (meth)acrylate monomer, and one or more acidic monomers, and optionally a hydrophobic monomer.

Filled and/or Pigmented Compositions

In some embodiments, the disclosure provides a polymerizable composition comprising a PCL urethane (meth)acrylate monomer, an acidic monomer, and one or more hydrophobic monomers. A filler may be also employed, for example, to convey control over optical properties. A more refined esthetic control may come from employing pigmentation. This allows both color and translucency to be tuned as appropriate for a given application. For example, in producing an aligner, a clear, color-free polymer may be utilized, but other applications may need access to color and translucency/opacity options. Optionally, a pigment may be employed in the polymerizable composition in a range of from about 0.0001-5 wt %, 0.001-1 wt %, or 0.003-0.5 wt %. For example, dry, finely ground pigments may be mechanically blended with the polymer particles for a specified amount of time. Pigments may include titanium dioxide, iron oxide, aluminum lake, zirconium oxide, etc. Optionally an opacifier may be employed.

In some embodiments, the disclosure provides a polymerizable composition comprising a PCL urethane (meth)acrylate monomer, an acidic monomer, and one or more hydrophobic monomers, an initiator, and one or more fillers and/or pigments.

In some embodiments, the disclosure provides a polymerizable composition comprising a PCL urethane (meth)acrylate monomer, an acidic monomer, and one or more hydrophobic monomers, an initiator, and one or more fillers with methacrylate silane surface treatment.

In some specific embodiments, the disclosure provides an exemplary composition as follows. Additional compositions employing other monomers of the disclosure were prepared.

Resin phase (referred to as the “standard resin”)
PCL 530 diol + IEM; PCL diurethane dimethacrylate monomer (1 eq) 30.9wt %
Methacrylic acid (MAA) (3 eq) 9.1 wt %
Isostearyl methacrylate (ISMA)(5 eq) 59.9 wt %
TPO ((triphenyl)phosphine oxide), 2.0 wt %*

*Mass of TPO is based on the resin phase, so its weight fraction is not included in the other weight fraction designations

Filler phase
Barium glass with methacrylate silane surface treatment (Ba glass)
Fumed silica with methacrylate silane surface treatment (OX50).

The dental materials of the present disclosure may optionally comprise additional adjuvants suitable for use in the oral environment, including surfactants, colorants, flavorants, anti-microbials, fragrance, stabilizers, viscosity modifiers and fluoride releasing materials. For example, a fluoride releasing glass may be added to the materials of the disclosure to provide the benefit of long-term release of fluoride in use, for example in the oral cavity. Fluoroaluminosilicate glasses can be employed. Silanol treated fluoroaluminosilicate glass fillers may be employed, as described in U.S. Pat. No. 5,332,429, the disclosure of which is expressly incorporated by reference herein. Other suitable adjuvants include agents that impart fluorescence and/or opalescence.

In some embodiments, the disclosure provides a method of using the polymerizable composition of the disclosure, comprising a PCL urethane (meth)acrylate and an acidic monomer, optionally comprising a hydrophobic monomer, and one or more optional fillers, the material is manipulated by the practitioner or laboratory to change the topography of the material, then followed by curing the polymerizable composition. These steps can be followed sequentially or in a different order. For example, in some embodiments the method comprises mixing the polymerizable composition, printing the polymerizable composition using a 3D printer to form a printed composition, and curing the printed composition. In some embodiments, the curing step may be completed prior to changing the topography of the material. Changing the topography of the material can be accomplished in various ways, such as carving or manual manipulation using hand held instruments, or by machine or computer aided apparatus, such as a CAD/CAM milling machine in the case of prostheses and mill blanks. Optionally, a finishing step can be performed to polish, finish, or apply a coating on the dental material.

The following examples are given to illustrate, but not limit, the scope of this disclosure. Unless otherwise indicated, all parts and percentages are by weight. Unless otherwise indicated, all numbers expressing quantities of ingredients, properties such as molecular weight, reaction conditions, and so forth used in the specification and claims are to be understood as being modified in all instances by the term “about.” The term “about” represents +/−10% of the numerical term to which it is applied.

Accordingly, unless indicated to the contrary, the numerical parameters set forth in the following specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

### EXAMPLES

Polymer flexural strength and modulus are calculated using a 3-point flexural test, carried out with a hydraulic universal test system (858 Mini Bionix, MTS Systems Corporation, Eden Prairie, MN, USA) using a span width of 10 mm and a crosshead speed of 1 mm/min. The flexural strength (FS, σ) in MegaPascals (MPa) and flexural modulus (modulus, E_{f}) in GigaPascals (GPa) were calculated using the following equations:

$$σ = \frac{3 F l}{2 b {h}^{2}} \qquad ( Equation 2 )$$

$${E}_{f} = \frac{{F}_{1} {l}^{3}}{4 b {h}^{3} d} \qquad ( Equation 3 )$$

where F is the peak load (in N), 1 is the span length (in mm), b is the specimen width (in mm), h is the specimen thickness (in mm); and d is the deflection (in mm) at load F₁ (in N) during the straight line portion of the trace according to ISO/DIS 4049, 2019). ISO/DIS 4049 is the international standard for “Dentistry—Polymer-based filling, restorative and luting materials”. Flexural strength test is one of the tests specified in this standard for the polymer-based filling, restorative and luting materials. In some embodiments, mechanical strength is tested on approximately eight specimens per sample (approximately 25 mm×2 mm×2 mm) and all samples are stored in water for at least 24 hours prior to flexural strength measurement.

Unless otherwise specified, photopolymerization is carried out using a VIP curing light (BISCO) at 500 mW/cm² for 40×3 seconds irradiation each side. Unless otherwise specified, the post-cure conditions were 80° C. for 1 hour with exposure to both 365 and 405 nm lights.

Near-Infrared spectroscopy (NIR) is performed on a Nicolet Nexus 670 to analyze degree of conversion during or following thermal polymerization.

Proton Nuclear Magnetic Resonance (¹H-NMR) can be used to integrate, thus quantify, protons of interest (Varian 300 MHz; performed in CDCl₃). For example, the CH₂ protons in EA, CH₂OCH₂ protons in TEGDMA, and CH₃ protons in dodecanethiol (C₁₂SH) at δ1.92, 3.75-60, and 0.89 ppm chemical shifts, respectively, were integrated. ¹H-NMR may be employed to determine average PCL (n) values.

Viscosity may be measured by any appropriate test method. In some embodiments, viscosity of polymerizable resin compositions may be measured by ASTM D2857 or ASTM D5225.

Example 1. PCL Triurethane Tri (Meth)Acrylate Monomer Preparation, Compositions and Properties

A PCL triurethane tri(meth)acrylate monomer of Formula (Ia)(FIG. 2) was prepared according to Scheme 1B from a three-arm triol structure comprising short polycaprolactone (PCL) segments, 4. A PCL triol (4) was purchased commercially (Sigma-Aldrich). The PCL triol 4 had a number average molecular weight of 300 Da, which means n˜1-1.5 PCL units on average per arm in this structure.

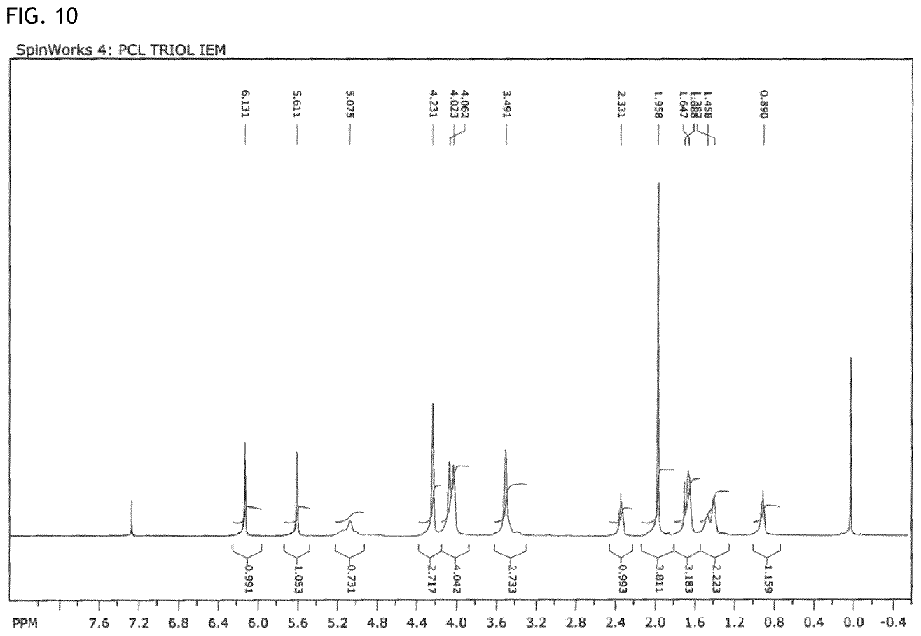

The PCL triol (4) was reacted with three equivalents of isocyanatoethyl methacrylate (IEM, m=1) 3 to provide the PCL triurethane tri(meth)acrylate monomer according to Formula (Ia) “PCL-Triol300 + IEM”, which in neat form has a relatively high monomeric viscosity (Table III.4.a) (17,695±1628 mPa.s) due to the extended urethane-urethane hydrogen bonding interactions. ¹H-NMR (600 MHz) of PCL-Triol₃₀₀ + IEMₑₓₜ is shown in FIG. 10.

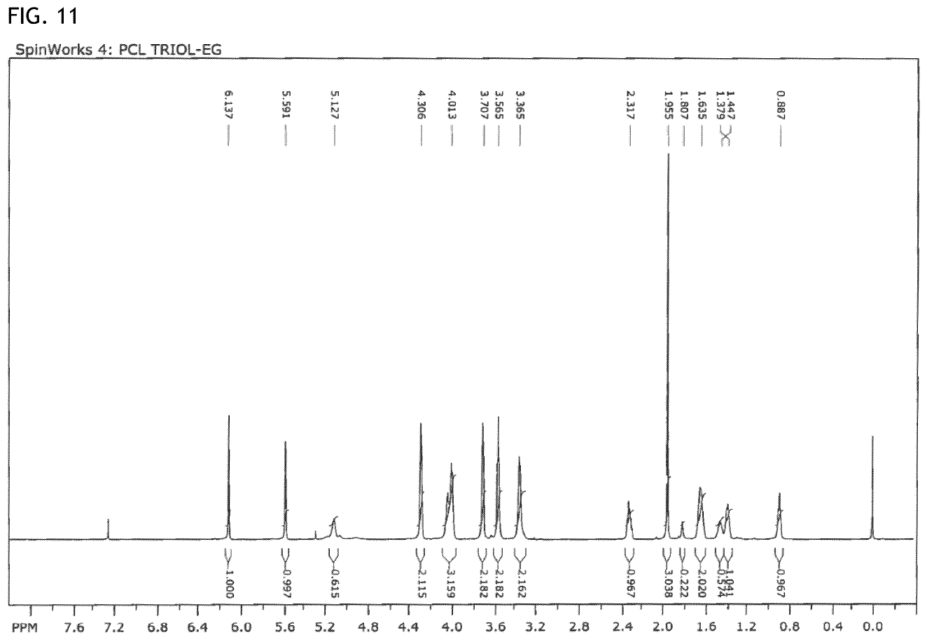

The PCL triol (4) was treated with about 3 molar equivalents of extended 2-isocyanatoethyl methacrylate (IEMₑₓₜ, m=2), to provide the PCL triurethane tri (meth)acrylate monomer (Ia) “PCL-Triol300+ IEMₑₓₜ”. ¹H-NMR (600 MHz) of PCL-Triol₃₀₀ + IEMₑₓₜ is shown in FIG. 11.

When the PCL triurethane tri(meth)acrylate monomer was photopolymerized under ambient conditions, the moderate limiting conversion (Table IA.4.a) can be raised to near quantitative conversion (Table IA.4.b) by a photo/thermal post-cure that involves irradiating at 80° C. with exposure to both 365 and 405 nm lights. Flexural mechanical properties and tensile mechanical properties of homopolymers and copolymers prepared from compositions comprising are shown in Tables IA and IIA, respectively.

TABLE IA
Flexural Mechanical Properties of PCL₃₀₀ Triol homopolymers and copolymers

| | | ref | | | | | | |
|---|---|---|---|---|---|---|---|---|
| | | | | c | cc | | dd | e |
| | | | | +IEM/ | +IEM/ | | +IEMₑₓₜ/ | +IEMext/ |
| | | a | b | MAA | MAA | d | MAA | MAA |
| | Test | +IEM* | +IEM | (1:1)^{♦} | (1:1.7)^{♦} | +IEMₑₓₜ | (1:1)^{♦} | (1:1.8)^{♦} |
| 1 | Flex | 51.8 ± | 97.6 ± | 176.4 ± | 143.5 ± | 74.3 ± | 151.2 ± | 180.3 ± |
| | strength, MPa | 4.5 | 13.3 | 13.8 | 14.4 | 3.5 | 11.4 | 12.2 |
| 2 | Flex | 1.04 ± | 2.05 ± | 3.57 ± | 2.67 ± | 1.56 ± | 3.02 ± | 3.52 ± |
| | modulus, GPa | 0.06 | 0.20 | 0.19 | 0.23 | 0.12 | 0.15 | 0.24 |
| 3 | Toughness, | 433 ± | 423 ± | 1518 ± | 1045 ± | 732 ± | 1844 ± | 1339 ± |
| | J/m³ | 109 | 104 | 563 | 505 | 65 | 941 | 683 |
| 4 | Conversion, % | 70.2 ± | 98.2 ± | n/a | 57.6 ± | 91.8 ± | n/a | 78.9 ± |
| | | 3.1 | 1.1 | | 2.8*/ | 4.0*/ | | 1.9*/ |
| | | | | | 83.6 ± | 98.1 ± | | 95.2 ± |
| | | | | | 1.8 | 0.9 | | 0.8 |
| 5 | DNF, % | 0 | 0 | 0 | 0 | 0 | 0 | 0 |

Unless noted otherwise, the post-cure conditions were 80° C. for 1 hour with exposure to both 365 and 405 nm lights.
*No post cure; n/a = not available; DNF = specimens that ‘did not fail’ at full extension in the flexural test.
Note:
For DNF specimens, the maximum stress is reported rather than stress at break.
^{♦}Ratio of urethane to acid functional groups.

TABLE IIA
Tensile Mechanical Properties of PCL₃₀₀ Triol homopolymers and copolymers

| | | | b | bb | | d | dd |
|---|---|---|---|---|---|---|---|
| | | | +IEM/ | +IEM/ | | +IEMₑₓₜ/ | +IEMₑₓₜ/ |
| | | a | MAA | MAA | c | MAA | MAA |
| | Test | +IEM | (1:1)^{♦} | (1:1.7)^{♦} | +IEMₑₓₜ | (1:1)^{♦} | (1:1.8)^{♦} |
| 1 | Tensile | 35.5 ± | 84.2 ± | 82.0 ± | 33.5 ± | 91.5 ± | 83.8 ± |
| | strength, MPa | 5.2 | 17.6 | 11.7 | 5.8 | 14.4 | 4.7 |
| 2 | Tensile | 1.42 ± | 2.43 ± | 2.33 ± | 1.56 ± | 3.60 ± | 1.83 ± |
| | modulus, GPa | 0.18 | 0.04 | 0.10 | 0.12 | 0.20 | 0.09 |
| 3 | Toughness, | 53.2 ± | 259 ± | 229 ± | 128.4 ± | 333 ± | 507 ± |
| | J/m³ | 20.2 | 183 | 62 | 52.6 | 118 | 153 |
| 4 | Strain at | 6.02 ± | n/a | 4.8 ± | 6.0 ± | n/a | 5.6 ± |
| | failure, % | 3.37 | | 2.2 | 1.3 | | 1.6 |

n/a = not available;
^{♦}Ratio of urethane to acid functional groups

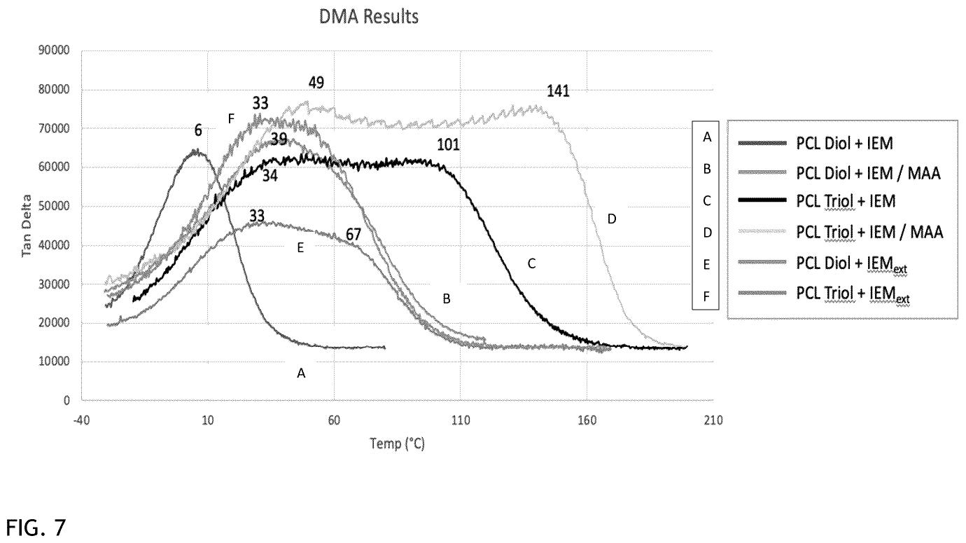

An unusual attribute of the PCL triol + IEM homopolymer of Formula (Ia) is the very broad glass transition temperature (Tg; V) that spans from <0° C. to more than 150° C. (FIG. 7, curve C). For an aliphatic methacrylate, the post-cured homopolymer has a reasonably high modulus and flexural strength (Table IA.1-2.b).

The copolymer formed from a composition including three equivalents of methacrylic acid (MAA) in the PCL₃₀₀ triol + IEM monomer formulation (1:1 urethane to acid functionalities) dramatically drops the resin viscosity (Table III.5.a) while significantly increasing the mechanical properties (flexural strength, modulus and toughness; Tables IA.1-3.c) relative to the urethane homopolymer even though the post-cured polymer displayed relative low final conversion (Table IA.4.c). Despite the lower conversion, the breadth of the copolymer Tg retained the thermal transition that stretched below room temperature and increased the high temperature transition that extended to ˜190° C. (FIG. 7, curve D). Without being bound by theory, this extensive thermal transition is likely important for achieving the high modulus along with very high toughness. It also allows the high modulus polymer to flex to significant degrees of deformation and then recover its initial shape spontaneously since there are both glassy and rubbery domains present in the polymer network.

As a variation to the PCL triol + IEM monomer of Formula (Ia), the same triol 4 was used with three equivalents of an extended version of IEM (IEMext, m=2) to produce an alternate triurethane trimethacrylate of Formula (Ia) with longer arms but the same PCL spacer lengths. Use of the extended IEM gives a monomer with about an order of magnitude reduction in bulk viscosity (Table III.6.a) and higher levels of ambient and post-cure conversion (Table IA.4.d) compared with the original monomer. Strength and modulus decreased relative to the bulk homopolymer of PCL triol + IEM (Table IA.1-2.d vs. b) and the breadth of the polymer Tg also decreased considerably (FIG. 7, curve F vs. curve C). However, when the PCL triol + IEM was formulated with three equivalents of MAA, the low viscosity resin provided extremely high strength, high modulus and high toughness copolymers (Table IA.1-3.e) that exceed the properties available with the smaller urethane monomer plus acid. This is likely due to the higher conversion obtained based on the extended IEM (Table IA.5.e) compared with the more compact analog formulation (Table IA.5.c).

TABLE III
Resin viscosity

| | | a |
|---|---|---|
| ref | Resin | Viscosity, mPa · s |
| 1 | PCL₅₃₀ Diol + IEM | 1226 ± 176 |
| 2 | PCL₅₃₀ Diol + IEM/MAA | 206 ± 8 |
| 3 | PCL₅₃₀ Diol + IEMₑₓₜ/MAA | 145 ± 4 |
| 4 | PCL₃₀₀ Triol + IEM | 17,695 ± 1628 |
| 5 | PCL₃₀₀ Triol + IEM/MAA | 59 ± 2 |
| 6 | PCL₃₀₀ Triol + IEMₑₓₜ | 1847 ± 36 |
| 7 | PCL₃₀₀ Triol + IEMₑₓₜ/MAA | 65 ± 5 |
| 8 | 2:1 PCL Diol:Triol + IEMₑₓₜ/MAA | 91 ± 4 |
| 9 | 1:1 PCL Diol:Triol + IEM/MAA | 154 ± 9 |
| 10 | 1:1 PCL Diol:Triol + IEMₑₓₜ/MAA | 83 ± 3 |
| 11 | 1:2 PCL Diol:Triol + IEM/MAA | 130 ± 10 |
| 12 | 1:2 PCL Diol:Triol + IEMₑₓₜ/MAA | 79 ± 2 |

The Fracture toughness K_{IC} of photocured PCL₃₀₀ Triol+IEMext/MAA (1:1) ratio of urethane to acidic functional groups was measured and is shown in Table V.

TABLE V
Fracture toughness

| | | a |
|---|---|---|
| | | PCL₃₀₀ Triol + IEMₑₓₜ/MAA (1:1) |
| 1 | Fracture toughness K_{IC}, MPa√m | 2.10 ± 0.42 |

Surprisingly, the fracture toughness K_{IC} was 2.10±0.42 MPa√m for the copolymer made from photocure of PCL₃₀₀ Triol+IEMₑₓₜ/MAA (1:1) having a 1:1 ratio of urethane to acidic functional groups. This is compared to fracture toughness K_{IC} of comparative control cured polymer materials BisGMA/TEGMA (7:3 mass), UDMA, or UDMA/MAA (1:1) ratio of urethane to acidic functional groups, that exhibited fracture toughness K_{IC} of only 0.83±0.51, 1.56±0.64, or 1.57±0.25 MPa√m, respectively, as shown in Table VII.

Example 2. PCL Diurethane Di(Meth)Acrylate Monomer Compositions and Properties

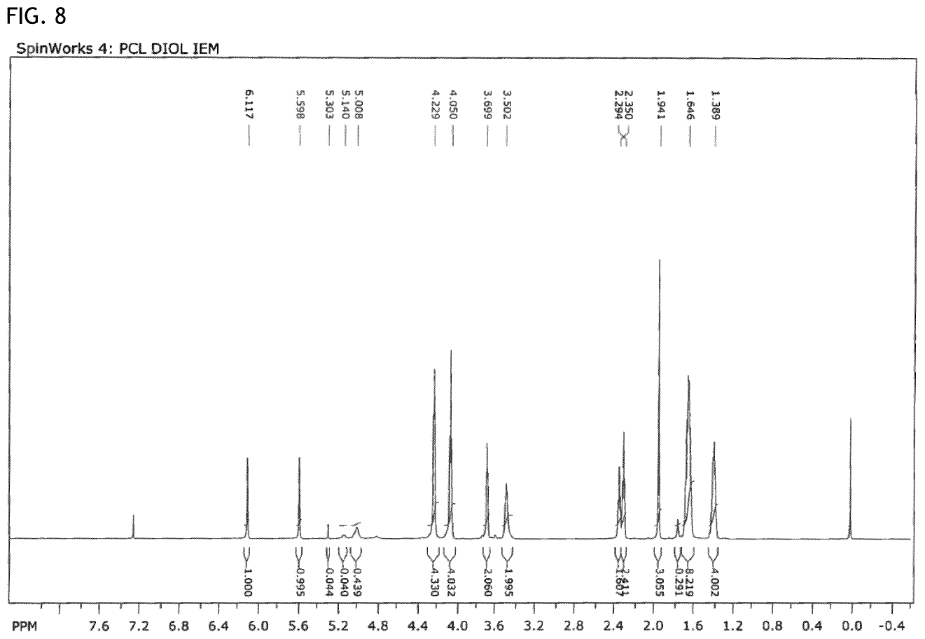

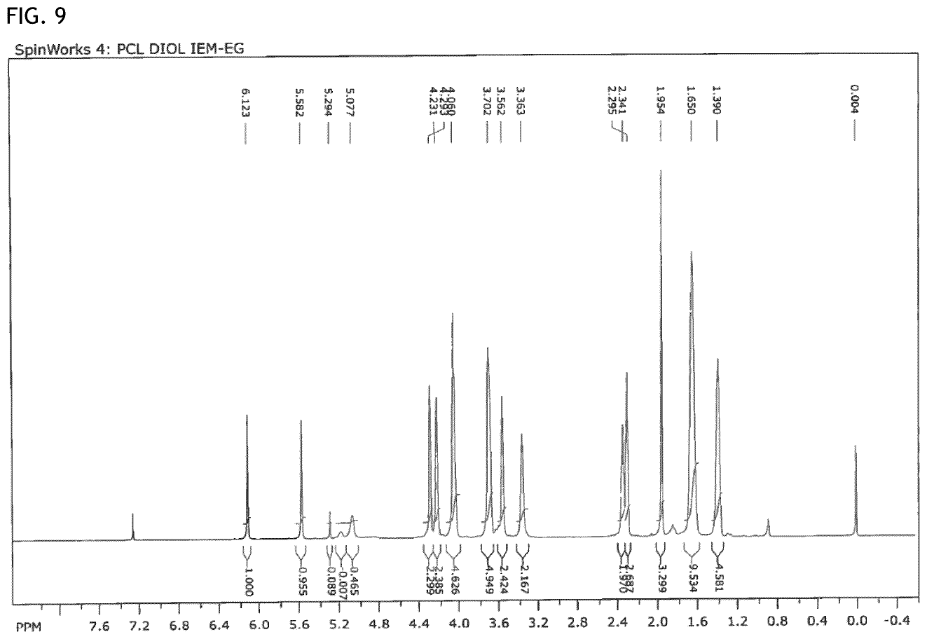

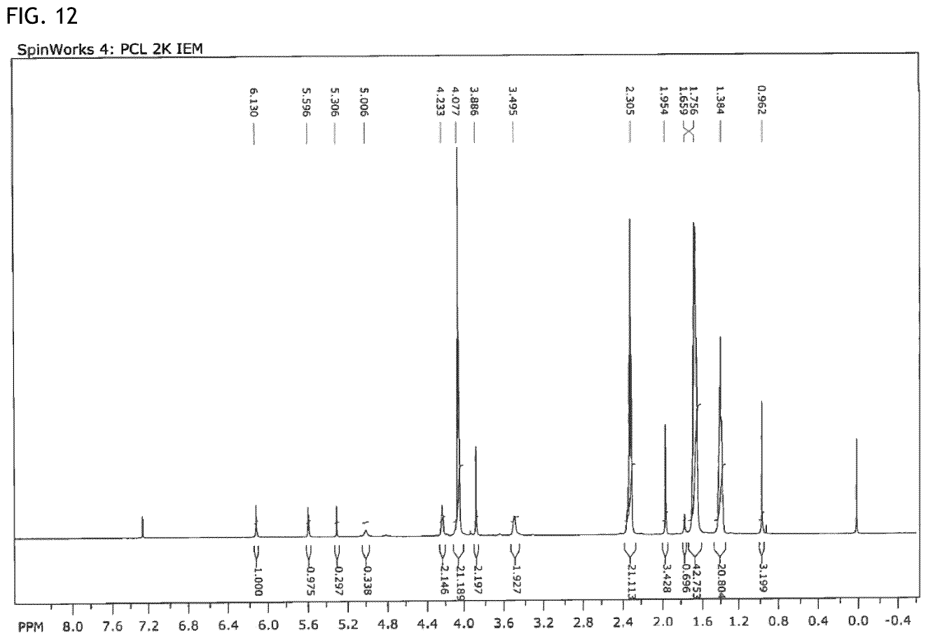

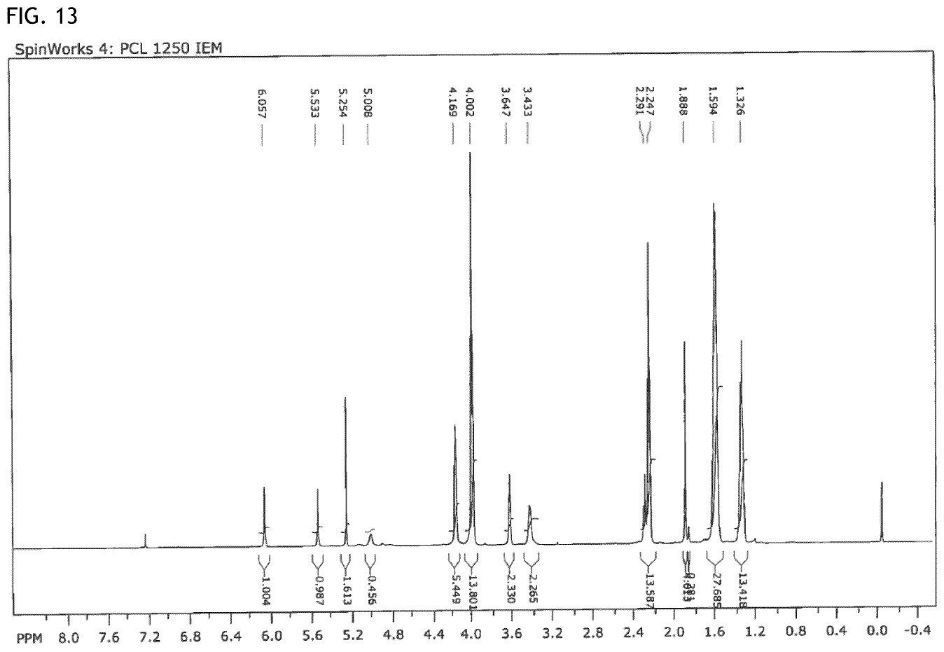

PCL diurethane di(meth)acrylate monomers according to Formula (Ib) were prepared according to Scheme II, FIG. 3 from diol structures (5)comprising short polycaprolactone (PCL) segments. Three PCL diols according to Formula (5) were obtained commercially from Sigma-Aldrich. A lower molecular weight PCL₅₃₀ diol having average Mₙ˜530 Da (5, each n˜2, p=1), which represents very short PCL segments. A more extended PCL₂₀₀₀ diol (5 each n˜8, p=1) having average M_{n˜}2,000 was also employed, although this diol is a waxy solid due to crystalline domains. An intermediate PCL_{1,250} diol having average Mₙ˜1250 Da was also employed. The PCL diurethane dimethacrylates of Formula (Ib) (FIG. 3) were obtained by reaction of two molar equivalents of IEM (3, m=1) or IEMₑₓₜ (3, m=2), with each PCL diol 5, including PCL diol 530, PCL diol 1,250, or PCL diol 2,000. ¹H-NMR (600 MHz) for PCL urethane methacrylates PCL-Diol₅₃₀+IEM, PCL-Diol₅₃₀+IEMₑₓₜ, PCL-Diol₂₀₀₀+IEM, and PCL-Diol_{1,250}+IEM are shown in FIGS. 8, 9, 12 and 13, respectively.

The lower molecular weight PCL₅₃₀ diol + IEM (each n˜2, p=1, m=1) returned a moderate viscosity monomer according to Formula (Ib)(Table III.1.a) having viscosity 1226+/−176 mPa.s. The homopolymer from PCL diol₅₃₀ +IEM (each n˜2, p=1, m=2) reached very high conversion under ambient photocuring conditions and required no post-curing (Table IB.9.f). As expected in that case, the homopolymer was a rubbery solid with very low strength and modulus (Table IB.6-7.f) with extreme flexibility, where no specimens failed to the limits of the three-point bending test. This behavior coincides with a polymeric Tg below room temperature that accounts for the rubbery polymer behavior as shown in FIG. 7, curve A.

With two molar equivalents of MAA added to the PCL diol₅₃₀ + IEM, the mechanical properties of the copolymer all increased dramatically (Table IB.6-8.g) while still achieving high levels of ambient photocure conversion that did not require any post-cure treatment. This polymer also did not fail at full deformation in the three point bend testing and it recovers its original shape when the load is released. The DMA results show the copolymer Tg rising and broadening out to about 100° C. (FIG. 7, curve B compared to curve A) but the polymer remains flexible and resilient again since the broad Tg encompasses a combination of both rubbery and glassy states. Flexural mechanical properties and tensile mechanical properties are shown in Tables IIA and IIB, respectively.

TABLE IB
Flexural Mechanical Properties of PCL₅₃₀ Diol homopolymers and copolymers

| | | | ff | g | h | i | ii | j |
|---|---|---|---|---|---|---|---|---|
| | | | +IEM/ | +IEM/ | +IEM/ | +IEM/ | +IEMₑₓₜ/ | +IEMₑₓₜ/ |
| | | f | MAA* | MAA* | MAA* | MAA | MAA | MAA |
| | Test | +IEM* | (1:1)^{♦} | (1:1.2)^{♦} | (1:1.8)^{♦} | (1:3.1)^{♦} | (1:1)^{♦} | (1:1.3)^{♦} |
| 6 | Flex | 4.7 ± | 27.4 ± | 59.6 ± | 71.6 ± | 130.5 ± | 9.6 ± | 15.7 ± |
| | strength, MPa | 0.6 | 0.8 | 0.4 | 4.2 | 4.2 | 1.5 | 1.2 |
| 7 | Flex | 0.037 ± | 0.53 ± | 1.20 ± | 1.43 ± | 2.63 ± | 0.13 ± | 0.29 ± |
| | modulus, GPa | 0.003 | 0.04 | 0.09 | 0.12 | 0.08 | 0.01 | 0.06 |
| 8 | Toughness, | 78 ± | 518 ± | 667 ± | 1221 ± | 2111 ± | 145 ± | 330 ± |
| | J/m³ | 13 | 82 | 116 | 124 | 108 | 35 | 22 |
| 9 | Conversion, % | 97.1 ± | n/a | 95.7 ± | 94.3 ± | 86.6 ± | n/a | n/a |
| | | 0.6 | | 0.5 | 0.5 | 1.3*/ | | |
| | | | | | | 98.2 ± | | |
| | | | | | | 0.3 | | |
| 10 | DNF, % | 100 | 0 | 100 | 100 | 100 | 0 | 71 |

Unless noted otherwise, the post-cure conditions were 80° C. for 1 hour with exposure to both 365 and 405 nm lights.
*No post cure; n/a = not available; DNF = specimens that ‘did not fail’ at full extension in the flexural test.
Note:
For DNF specimens, the maximum stress is reported rather than stress at break.
^{♦}Ratio of urethane to acid functional groups.

TABLE IIB
Tensile Mechanical Properties of PCL₅₃₀ Diol homopolymers and copolymers

| | | | f | ff | fff | g | h |
|---|---|---|---|---|---|---|---|
| | | | +IEM/ | +IEM/ | +IEM/ | +IEMₑₓₜ/ | +IEM/ |
| | | e | MAA* | MAA* | MAA* | MAA | MAA |
| | Test | +IEM* | (1:1)^{♦} | (1:1.2)^{♦} | (1:1.8)^{♦} | (1:1)*^{♦} | (1:1.3)*^{♦} |
| 5 | Tensile | 4.77 ± | 33.5 ± | 17.6 ± | 50.6 ± | 15.8 ± | 6.7 ± |
| | strength, MPa | 1.09 | 1.3 | 0.9 | 3.3 | 3.0 | 1.6 |
| 6 | Tensile | 0.023 ± | 0.70 ± | 0.29 ± | 1.51 ± | 0.20 ± | 0.04 ± |
| | modulus, GPa | 0.002 | 0.03 | 0.02 | 0.07 | 0.04 | 0.01 |
| 7 | Toughness, | 67.6 ± | 515 ± | 484 ± | 734 ± | 567 ± | 138 ± |
| | J/m³ | 21.0 | 92 | 68 | 411 | 215 | 89 |
| 8 | Strain at | 24.7 ± | n/a | 21.4 ± | 22.9 ± | 49.8 ± | n/a |
| | failure, % | 4.1 | | 3.8 | 5.6 | 11.5 | |

*No post cure; n/a = not available;
^{♦}Ratio of urethane to acid functional groups.

The use of the extended IEM (3, m=2) in the reaction with the PCL₅₃₀ diol gave a somewhat larger diurethane dimethacrylate that when combined with two molar equivalents of MAA, provides a copolymer with very large drops in all mechanical properties (Table IB.6-8.j). There were also some flexural strength specimens that failed during the three point bend testing, which was not the case with any of the other PCL₅₃₀ + IEM formulations with or without MAA.

Example 3. Use of Various Amounts of Acidic Monomer in PCL Urethane (Meth)Acrylate Copolymers

The PCL diol₅₃₀ + IEM resin diurethane dimethacrylate monomer was mixed with either three equivalents or five equivalents of acidic monomer MAA relative to the monomer's two urethane groups and photocured. The respective increases in the copolymer mechanical properties were significant (Table IB,6-8.h-i). For example, flexural strength of the copolymers increased from 59.6+/−0.4 MPa, to 71.6+/−4.2, to 130.5+/−4.2 MPa as monomer urethane:MAA ratio was increased from 1:1, to 1:3, to 1:5, respectively. Flexural modulus of the copolymer also increased from 1.20 GPa, to 1.43 GPa, to 2.63 GPa as monomer urethane:MAA ratio was increased from 1:1, to 1:3, to 1:5, respectively. A significant increase in toughness of the copolymers increased from 667 J/m³ to 1221 J/m³ to 2111 J/m³ as monomer urethane:MAA ratio was increased from 1:1, to 1:3, to 1:5, respectively.

With the five equivalents of MAA in the formulation, the photocured copolymer required post curing to reach a high level of conversion. Here, a high modulus was achieved without compromise to the extremely flexible and recovery with no failed three-point bend specimens at full extension.

Example 4. PCL₂₀₀₀ Diol Homopolymers and Copolymers

PCL diurethane di (meth)acrylate monomers according to Formula (Ib) were prepared according to Scheme 1B from diol structures ( )comprising higher molecular weight polycaprolactone (PCL) segments. The higher molecular weight PCL₂₀₀₀ + IEM monomer required pre-heating to melt the crystalline domains before polymerization. This was necessary even with the MAA included in the formulation although none of the extended diol resins needed post curing. Properties are shown in Table IC. The higher molecular weight PCL₂₀₀₀ diol dimethacrylate produced a high conversion that was extremely flexible but very low modulus and strength (Table IC.11-14.k). As expected, these samples do not fail in the flexural strength testing. The addition of two equivalents of MAA to the PCL₂₀₀₀ + IEM diurethane dimethacrylate monomer did not result in any increase in mechanical properties compared to the homopolymer (Table IC.11-13.k-1). The further increase in MAA to either five or ten equivalents gave marginal increases in mechanical properties (Table I.11-13.m-n) but these remained very weak and flexible copolymers that were not reinforced by potential for semi-crystalline domain formation.

TABLE IC
Flexural Mechanical Properties of PCL₂₀₀₀ Diol homopolymers and copolymers

| | | | l | m | n |
|---|---|---|---|---|---|
| | | k | +IEM/ | +IEM/ | +IEM/ |
| | Test | +IEM* | MAA (1:1.1)*^{♦} | MAA(1:2.7)*^{♦} | MAA(1:5.4)*^{♦} |
| 11 | Flex strength, MPa | 1.6 ± 0.3 | 1.4 ± 0.1 | 5.9 ± 0.9 | 16.0 ± 0.7 |
| 12 | Flex modulus, GPa | 0.013 ± 0.004 | 0.013 ± 0.001 | 0.124 ± 0.066 | 0.334 ± 0.026 |
| 13 | Toughness, J/m³ | 27 ± 3 | 23 ± 6 | 91 ± 10 | n/a |
| 14 | Conversion, % | 96.4 ± 1.3 | 98.8 ± 0.5 | 98.6 ± 0.5 | 98.3 ± 0.9 |
| 15 | DNF, % | 100 | 100 | 100 | 100 |

Unless noted otherwise, the post-cure conditions were 80° C. for 1 hour with exposure to both 365 and 405 nm lights.
*No post cure; n/a = not available; DNF = specimens that ‘did not fail’ at full extension in the flexural test.
Note:
For DNF specimens, the maximum stress is reported rather than stress at break.
^{♦}Ratio of urethane to acid functional groups

TABLE IIC
Tensile Mechanical Properties of
PCL₂₀₀₀ Diol homopolymer and copolymer

| | | | j |
|---|---|---|---|
| | | i | +IEM/ |
| | Test | +IEM* | MAA(1:1.1)*^{♦} |
| 9 | Tensile strength, MPa | 0.82 ± 0.16 | 1.56 ± 0.09 |
| 10 | Tensile modulus, GPa | 0.013 ± 0.004 | 0.010 ± 0.001 |
| 11 | Toughness, J/m³ | 5.37 ± 2.28 | 18.8 ± 0.9 |
| 12 | Strain at failure, % | 13.6 ± 2.3 | 21.3 ± 1.0 |

*No post cure;
^{♦}Ratio of urethane to acid functional groups

Example 5. Blended PCL Diurethane Di(Meth)Acrylate Monomer and PCL Triurethane Tri(Meth)Acrylate Monomer Compositions and Properties

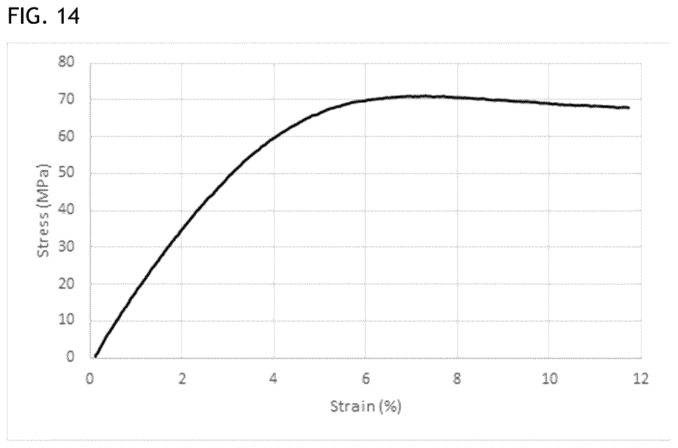

Mixtures of the PCL₅₃₀ diol of Formula (Ib) and PCL₃₀₀ triol urethane monomers of Formula (Ia) with diol to triol mass ratios of 2:1, 1:1, or 1:2, with IEM or IEMₑₓₜ were prepared for copolymerization with a stoichiometric balance of MAA to the overall urethane group content. A range of diol/triol combinations were blended including PCL urethane monomers made with either the conventional IEM (3, m=1)or the extended IEM (3, m=2). Flexural mechanical properties are shown in Table ID. Tensile mechanical properties are shown in Table IID. The mechanical properties obtained for these photocured copolymers were generally intermediate between the component resins, but in some cases, enhanced properties were achieved. FIG. 14 shows a stress-strain plot for the 3-point bending testing of the 1:1 PCL-diol₅₃₀+IEM/ PCL-triol₃₀₀+IEM with a stoichiometric balance of MAA relative to the overall urethane group functionality. It highlights the unusual high stress plateau that is observed with these PCL-based materials. It is primarily this characteristic that is responsible for the high levels of toughness achieved with these polymers. The highest flexural toughness value in all these PCL urethane/acid samples was obtained with the 1:1 PCL diol/triol + extended IEM resin with MAA (Table ID.18.s).

TABLE ID
Flexural Mechanical Properties of PCL₅₃₀ Diol and
PCL₃₀₀ Triol mixtures (diol to triol mass ratio) copolymers

| | | ref | | | | | | |
|---|---|---|---|---|---|---|---|---|
| | | o | p | q | r | s | t | u |
| | | 2:1 + | 2:1 + | 2:1 + | 1:1 + | 1:1 + | 1:2 + | 1:2 + |
| | | IEM/ | IEMₑₓₜ/ | IEMₑₓₜ/ | IEM/ | IEMₑₓₜ/ | IEM/ | IEMₑₓₜ/ |
| | Test | MAA | MAA* | MAA | MAA | MAA | MAA | MAA |
| 16 | Flex | 119.8 ± | 61.4 ± | 85.0 ± | 134.6 ± | 111.6 ± | 167.9 ± | 136.4 ± |
| | strength, MPa | 5.2 | 3.2 | 3.6 | 5.4 | 2.4 | 3.7 | 11.0 |
| 17 | Flex | 2.22 ± | 1.36 ± | 1.77 ± | 2.26 ± | 2.21 ± | 3.21 ± | 2.94 ± |
| | modulus, GPa | 0.14 | 0.05 | 0.05 | 0.13 | 0.10 | 0.14 | 0.23 |
| 18 | Toughness, | 1852 ± | 963 ± | 1271 ± | 1695 ± | 2467 ± | 1876 ± | 2006 ± |
| | J/m³ | 463 | 99 | 206 | 106 | 266 | 280 | 367 |
| 19 | Conversion, % | 90.1 ± | 93.6 ± | 95.1 ± | 88.6 ± | 89.4 ± | 78.8 ± | 85.7 ± |
| | | 1.1*/ | 2.2 | 0.9*/ | 1.7*/ | 0.7*/ | 2.0*/ | 1.7*/ |
| | | 97.8 ± | | 99.0 ± | 97.8 ± | 98.4 ± | 97.7 ± | 97.6 ± |
| | | 0.4 | | 0.6 | 0.6 | 0.5 | 0.8 | 0.5 |
| 20 | DNF, % | 0 | 100 | 71 | 0 | 71 | 0 | 57 |

*No post cure; DNF = specimens that ‘did not fail’ at full extension in the flexural test.
Note:
For DNF specimens, the maximum stress is reported rather than stress at break.

TABLE IID
Tensile Mechanical Properties of PCL₅₃₀ Diol and
PCL₃₀₀ Triol mixtures (diol to triol mass ratio) copolymers

| | | k | l | m | n | o | p | q |
|---|---|---|---|---|---|---|---|---|
| | | 2:1 + | 2:1 + | 2:1 + | 1:1 + | 1:1 + | 1:2 + | 1:2 + |
| | | IEM/ | IEMₑₓₜ/ | IEMₑₓₜ/ | IEM/ | IEMₑₓₜ/ | IEM/ | IEMₑₓₜ/ |
| | Test | MAA | MAA* | MAA | MAA | MAA | MAA | MAA |
| 13 | Tensile | 66.3 ± | 35.1 ± | 48.1 ± | 89.1 ± | 67.6 ± | 99.6 ± | 75.9 ± |
| | strength, MPa | 5.2 | 1.3 | 1.2 | 3.9 | 1.9 | 4.5 | 4.7 |
| 14 | Tensile | 1.56 ± | 1.05 ± | 1.30 ± | 2.08 ± | 1.70 ± | 2.09 ± | 1.96 ± |
| | modulus, GPa | 0.07 | 0.06 | 0.04 | 0.10 | 0.06 | 0.18 | 0.11 |
| 15 | Toughness, | 664 ± | 590 ± | 482 ± | 503 ± | 561 ± | 432 ± | 300 ± |
| | J/m³ | 226 | 174 | 160 | 176 | 108 | 199 | 189 |
| 16 | Strain at | 12.5 ± | 18.74 ± | 13.49 ± | 8.04 ± | 10.67 ± | 7.70 ± | 6.00 ± |
| | failure, % | 3.5 | 4.51 | 2.80 | 1.83 | 1.52 | 1.83 | 2.39 |

*No post cure

Example 6. ISMA-Modified Resins

Copolymer compositions comprising diurethane dimethacrylates of Formula (Ib) obtained by reaction of two equivalents of IEM (m=1) with PCL₅₃₀ diol, MAA (either 3 or 5 equivalents) and hydrophobic monomer highly branched ISMA (either 5 or 10 equivalents) were prepared and photocured. Flexural mechanical properties are shown in Table IV. The addition of highly branched ISMA (5 eq), to PCL₅₃₀ Diol + IEM/MAA(×3) (Table IV.1-3.a) resulted in an significant increase in flexural strength, flexural modulus and toughness compared to PCL₅₃₀ Diol + IEM/MAA(1:1.8) (Table IB.6-8.h). However, doubling the ISMA(10 eq) reduced flexural strength, flexural modulus and toughness compared to ISMA (5 eq). (Table IV.1-3.b). Increasing MAA (×5) from MAA(×3) using ISMA(10) significantly decreased flexural strength and toughness (Table IV.1-3, c).

TABLE IV
Flexural Mechanical Properties of
PCL₅₃₀ Diol + IEM/MAA(x)/ISMA(y) copolymers

| | | a | b | c |
|---|---|---|---|---|
| | | MAA(×3)/ | MAA(×3)/ | MAA(×5)/ |
| | Test | ISMA(5) | ISMA(10) | ISMA(10) |
| 1 | Flex strength, MPa | 197.0 ± 16.2 | 158.4 ± 13.3 | 125.2 ± 22.3 |
| 2 | Flex modulus, GPa | 3.72 ± 0.40 | 3.09 ± 0.27 | 4.07 ± 0.43 |
| 3 | Toughness, J/m³ | 1868 ± 684 | 795 ± 149 | 225 ± 71 |
| 4 | Conversion, % | n/a | n/a | n/a |
| 5 | DNF, % | 0 | 0 | 0 |

n/a = not available; DNF = specimens that ‘did not fail’ at full extension in the flexural test

Example 7. Properties of Control Materials

Properties of comparative polymerized control resins are shown in Table VII. Structure of comparative non-PCL urethane (meth)acrylate monomer UDMA is shown in FIG. 5.

TABLE VII
Properties of Control Materials

| | | a | | c |
|---|---|---|---|---|
| | | BisGMA/ | | UDMA/ |
| | | TEGDMA | b | MAA |
| | | (7:3 mass) | UDMA | (1:1)^{♦} |
| 1 | Flexural strength, | 115.7 ± 20.7 | 157.6 ± 6.5 | 179.7 ± 25.0 |
| | MPa | | | |
| 2 | Flexural modulus, | 3.20 ± 0.15 | 3.13 ± 0.12 | 4.14 ± 0.31 |
| | GPa | | | |
| 3 | Toughness, J/m³ | 346 ± 241 | 217 ± 138 | 291 ± 106 |
| 4 | Fracture | 0.83 ± 0.51 | 1.56 ± 0.64 | 1.57 ± 0.25 |
| | toughness (K_{IC}), | | | |
| | MPa√m | | | |

^{♦}Ratio of urethane to acid functional groups

The photocured compositions of the disclosure comprising a PCL urethane (meth)acrylate and an acidic monomer exhibited increased toughness compared to polymerized Control Materials. For example, control material polymerized UDMA/MAA (1:1 urethane/acidic functional groups) exhibited toughness of 291 J/m³, as shown in Table VIII, whereas photocured PCL₃₀₀ triol+IEM/MAA using from 1:1 to 1:1.8 urethane to acidic functional groups each exhibited toughness of>1,000 J/m³ as shown in Table IA.3.c, cc, dd, and e. A dramatic increase in toughness was also seen when combining PCL₅₃₀ Diol + PCL₃₀₀ Triol mixtures with IEM with MAA, as shown in Table ID. As discussed above, FIG. 14 shows a stress-strain plot for the 3-point bending testing of the 1:1 PCL-dio₅₃₀+IEM/PCL-triol₃₀₀+IEM with a stoichiometric balance of MAA relative to the overall urethane group functionality. It highlights the unusual high stress plateau that is observed with these PCL-based materials. It is primarily this characteristic that is responsible for the high levels of toughness achieved with these polymers.

Example 8. PCL Diol Tetraurethane Di(Meth)Acrylate Resins

This example demonstrates that the order in which the urethane-forming reactions are conducted produces analog copolymers that display substantial mechanical property differences.

IPDI (isophorone diisocyanate) presents two isocyanate groups with different reactivities. The secondary isocyanate group is more reactive than the primary isocyanate group.

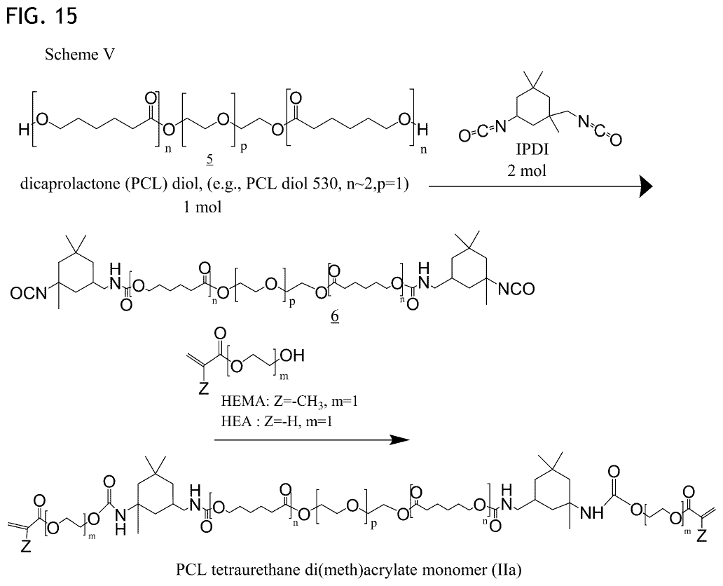

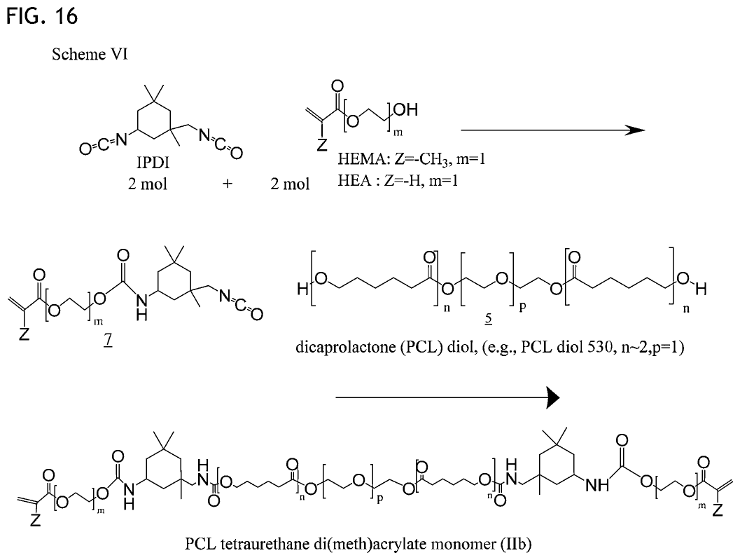

A tetra-urethane dimethacrylate, described as IPDI + PCL Diol + HEMA-C1 (a in Table VIII) was prepared as shown in FIG. 15, Scheme V.2 moles of IPDI were reacted with 1 mole of PCL diol₅₃₀ followed by the reaction with 2 moles of HEMA-C1 (2-hydroxyethyl methacrylate) to obtain PCL tetraurethane di(meth)acrylate monomer of Formula (IIa). By reversing the order of reaction as shown in FIG. 16, Scheme VI, IPDI + HEMA-C1 + PCL Diol (b in Table VIII) was prepared by the reaction of 2 moles of IPDI with 2 moles of HEMA-C1 followed by reaction with 1 mole of PCL diol₅₃₀ to obtain the PCL tetraurethane di(meth)acrylate monomer of Formula (IIb). In each case, the resultant tetra-urethane dimethacrylate monomers were combined with methacrylic acid (MAA) to provide a stoichiometric balance between the urethane and acid functional groups. The resins were prepared and photocured. Flexural mechanical properties are shown in Table VIII.

TABLE VIII
Synthetic sequence affects polymer properties

| | | IIa | IIb |
|---|---|---|---|
| | | IPDI + PCL Diol + | IPDI + HEMA-C1 + |
| | Test | HEMA-C1/MAA | PCL Diol/MAA |
| 1 | Flexural strength, MPa | 64.1 ± 2.0 | 177.2 ± 15.5 |
| 2 | Flexural modulus, GPa | 1.34 ± 0.04 | 4.11 ± 0.12 |
| 3 | Toughness, J/m³ | 11.8 ± 0.74 | 5.4 ± 1.3 |

As shown in Table VIII, is evident that the polymeric strength and modulus are dramatically higher for the latter formulation of PCL tetraurethane di(meth)acrylate monomer of Formula (IIb) although the toughness is reduced compared to (IIa).

Therefore, the order in which the urethane-forming reactions are conducted produces analog copolymers that display substantial mechanical property differences. As shown in FIG. 15 and FIG. 16, the difference in the monomer structures of Formula (IIa) and Formula (IIb) that then produces these very different polymeric mechanical properties is the configuration of the IPDI-based segments relative to the reactive and the PCL core groups. It is unexpected that simply reversing the configuration of the isophorone linkages in these monomers would lead to these dramatically different polymer property disparities, as shown in Table VIII.

Example 9. PCL-Diol IEM +MAA Hysteresis (5× Acid to Urethane Ratio)

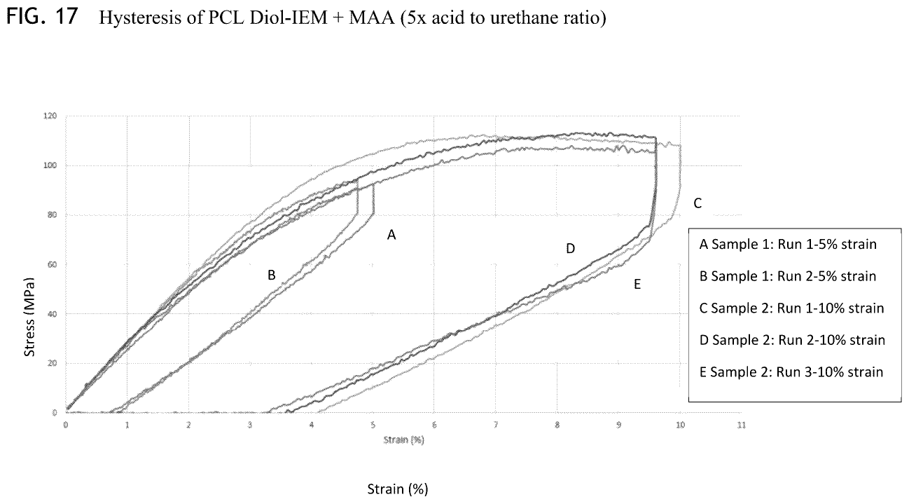

The copolymer of PCL Diol-IEM + MAA (5× acid to urethane ratio) was subjected to three-point bending mode (MTS universal testing device using a crosshead speed of 1 mm/min) to obtain a stress-strain plot as shown in FIG. 17. The 2×2×25 mm specimen was loaded to 5% strain, held for 30 seconds and then unloaded at the same crosshead rate. The spatial recovery of the bar specimen closely tracked the crosshead and within a few minutes had spontaneously recovered to its original linear shape. At that point the process was repeated for a second cycle to the 5% stain level. The load/unload cycling was repeated for another three cycles with the strain taken out to 10%. With the more extensive strain, the spontaneous dimensional recovery took longer but was still achieved under ambient conditions. This cyclic mechanical testing on a single specimen shows that the slope and strain-dependent stress levels were quite reproducible indicating little or no damage or irrecoverable deformation was introduced through these loading/unloading cycles. The equation for the calculation of strain in flexure (εƒ) during three-point bending is εƒ=6Dd/L² where D is the center point beam deflection, d is the beam thickness and L is the span length (all in mm).

Example 10. Hysteresis of PCL Triol-IEMEG +MAA (1:1 Acid to Urethane Ratio)

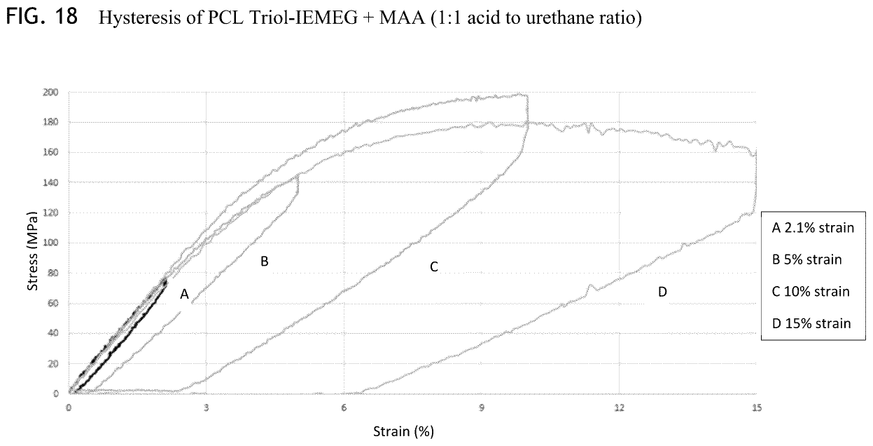

The copolymer of PCL triol-IEMEG +MAA (1:1 acid to urethane ratio) was subjected to three-point bending mode (MTS universal testing device) to obtain a stress-strain plot as shown in FIG. 18. IEMEG is equivalent to IEMₑₓₜ according to Formula 3 (m=2, z=CH₃) as shown in FIG. 3. The 2×2×25 mm specimen was loaded to 2.1% strain at 1 mm/min, held for 30 seconds and then unloaded. The bar specimen spontaneously recovered its original shape upon unloading from the 2 and 5% strain and while it likely would have eventually returned from the 10 and 15% strain deformation, the recovery process was rapidly facilitated by application of heat (heat gun at ˜80° C. for 5 seconds), which immediately restored the original linear bar shape. This cyclic mechanical treatment shows that there is no change in the slope (and thus modulus) of the polymer and that the strain-dependent stress continues to reach the very impressive 180-200 MPa flexural strength levels characteristic of this material. The reproducible properties indicate that little or no damage and irrecoverable deformation based on plastic yielding or stress relaxation was introduced through these loading/unloading cycles.

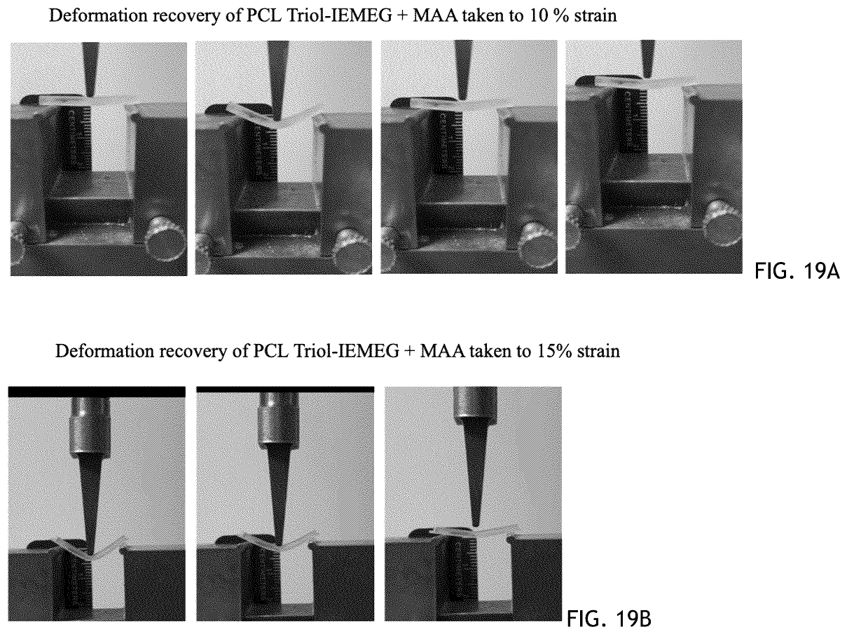

FIG. 19A shows time lapse photographs of deformation recovery of PCL Triol-IEMEG + MAA (1:1 acid to urethane ratio) taken to 10% strain. The photographs taken from left to right at 0 sec, 185 sec, 400 sec, and 600 sec, respectively, show significant recovery of the copolymer.

FIG. 19B shows time lapse photographs of deformation recovery of PCL Triol-IEMEG + MAA (1:1 acid to urethane ratio) taken to 15% strain. The photographs taken from left to right at 300 sec, 600 sec, and 1200 sec, respectively, show significant recovery of the copolymer.

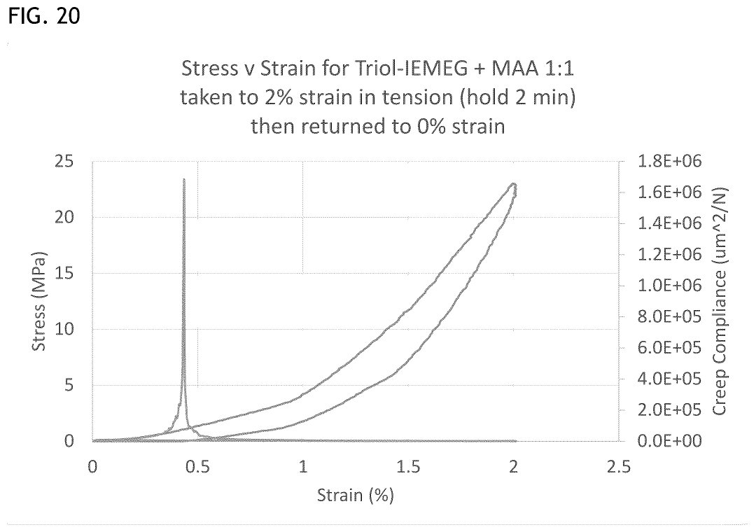

A stress-strain plot in tension using ambient dynamic mechanical analysis (DMA) for the PCL triol-IEMEG + MAA (1:1) copolymer is shown in FIG. 20. The sample was taken to 2% strain in tension (hold 2 min), then returned to 0% strain. The plot shows significant spontaneous recovery of the polymer.

Example 11. Hydrolytic Stability of PCL Diol₅₃₀-IEM + MAA

A 2×2×25 mm test copolymer specimen was made from PCL Diol₅₃₀-IEM + MAA at an acid to urethane ratio of 1.3, photocured, and stored in distilled water for over 18 months. There was no degradation apparent on the surface or within the bulk of the polymer (shape edges and glossy surfaces are completely retained). This highlights that the intimate presence of the PCL-based polyester units with the acidic functional groups in these copolymers does not promote any hydrolytic instability in these materials.

1. A polymerizable resin composition comprising a PCL urethane meth)acrylate monomer, and an acidic monomer.

2. The polymerizable resin composition according to claim 1, wherein the ratio of the urethane moieties from the PCL urethane (meth)acrylate monomer and the acidic moieties from the acidic monomer are in a urethane moiety:acidic moiety ratio of 1:1 to 1:10, 1:1 to 1:5, or 1:1 to 1:3.

3. The polymerizable composition according to claim 1, further comprising one or more hydrophobic monomers.

4. The polymerizable resin composition according to claim 3, wherein the weight ratio of PCL urethane (meth)acrylate monomers plus acidic monomers compared to hydrophobic monomers is selected from about 99:1 to 50:50; 90:10 to 60:40; 85:15 to 75:25, or about 80:20.

5. The polymerizable resin composition according to claim 1, wherein the PCL urethane (meth)acrylate monomer comprises a chemical structure according to Formula (I): 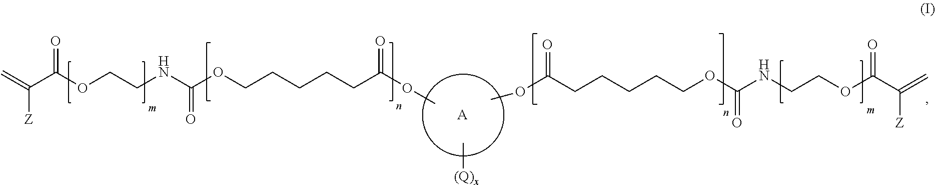
wherein A=aliphatic, aromatic, alkoxyalkyl, alkoxy, hydroxyalkyk, or alkoxycarbonyl core structure; independently each n=0-12, wherein at least one n≠0; x=0-6; each m=1-5; t=CH₃ or H; and Q=OH or OR, and where

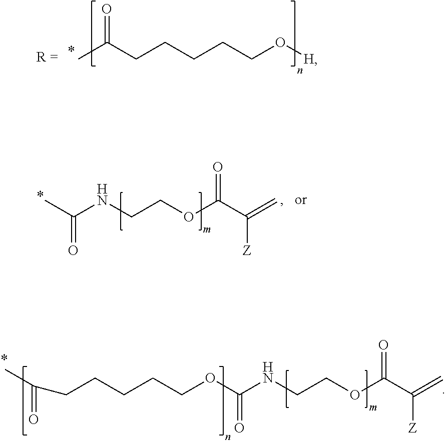

6. The polymerizable resin composition according to claim 5, wherein A=straight or branched chain C₂₋₁₂ aliphatic or alkylalkoxy; independently each n=avg. 1-5; x=0-3; Z=CH₃; and m=1-3.

7. The polymerizable resin composition according to claim 1, wherein the PCL urethane (meth)acrylate monomer is a PCL tetraurethane di(meth)acrylate monomer according to Formula (IIa) or (IIb): 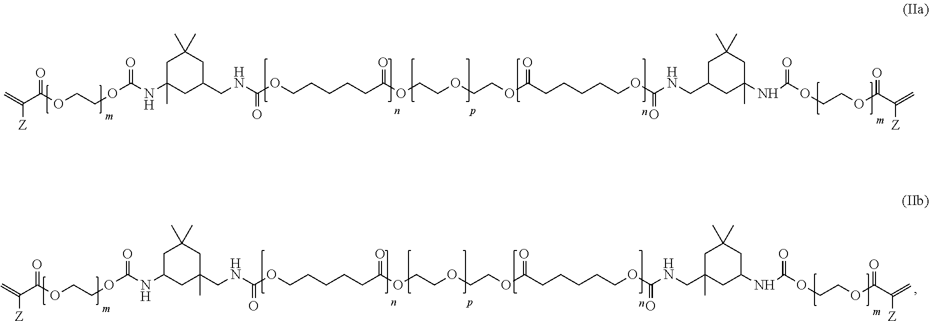
wherein n=1 to 10, m=1 to 5, p=0 to 12, and z=H or C₃; optionally wherein n=1 to 5, m=1 to 3, p=1 to 6.

8. The polymerizable resin composition according to claim 1, wherein the acidic monomer is selected from the group consisting of methacrylic acid (MAA), acrylic acid, itaconic acid, mono-2-(methacryloyloxy)ethyl maleate, pyromellitic dianhydride glycerol dimethacrylate, 2-carboxyethyl acrylate, 2-carboxyethyl acrylate oligomer, mono-2-(methacryloyloxy)ethyl succinate, glycerol dimethacrylatelsuccinate adduct, 1,3-glycerol dimethacrylate/maleate adduct, bis[2-(methacryloyloxy)ethyl] phosphate, or ethylene glycol methacrylate phosphate.

9. The polymerizable resin composition according to claim 3, wherein the hydrophobic monomer is selected from the group consisting of isostearyl (meth)acrylate (ISMA), ethoxylated bisphenol A di(meth)acrylate (EBDMA), stearyl (meth)acrylate, lauryl (meth)acrylate, isodecyl (meth)acrylate, 2-ethylhexyl (meth)acrylate, isobornyl(meth)acrylate and cyclohexyl (meth)acrylate.

10. The polymerizable resin composition according to claim 1, further comprising an initiator.

11. The polymerizable resin composition of claim 10, wherein the initiator is selected from a thermal initiator or a photoinitiator.

12. The polymerizable resin composition according to claim 1, wherein the unfilled polymerizable resin composition exhibits a viscosity of no more than 100 mPa.s, no more than 300 mPa.s, or no more than 1000 mPa.s.

13. The polymerizable resin composition according to claim 1, wherein following photocuring the resultant photocured copolymer composition exhibits:
flexural modulus of greater than 1.0 GPa, 2.0 GPa, 3.0 GPa, 4.0 GPa or higher; or from
1-5 GPa, from 2-5 GPa, or from 3-5 GPa;
flexural strength of greater than 50 MPa, 75 MPa, 100 MPa, or 150 MPa;
mechanical toughness of greater than 500 J/m³, 1000 J/m³, or 1200 J/m^{3;}
conversion of greater than 50%, 55%, 75%, 85%, 90%, or greater than 95%; and/or fracture toughness K_{IC} greater than 2.0 MPa√m.

14. A method for creating a two-dimensional film or a three-dimensional shaped part comprising molding, free-form fabricating, or printing of the polymerizable resin composition according to claim 1.

15. The method according to claim 14, comprising: three-dimensional (3D) printing of the polymerizable resin composition to form a partially or fully cured shaped part; and
optionally subjecting to additional post-cure processing to complete production of the shaped part.

16. The method of claim 14, wherein the shaped part is a shaped dental appliance, dental prosthetic device, biomedical device, automotive part, aerospace part, plumbing part, or electrical part.

17. A shaped part comprising: a copolymer created from the polymerization of the polymerizable resin composition according to claim 1, optionally in admixture with one or more fillers.

18. The shaped part according to claim 17, wherein the copolymer exhibits hydrolytic stability in water for at least 18 months at ambient temperature.

19. A polymerizable dental appliance or prosthetic material comprising: the polymerizable resin composition of claim 1, and optionally fillers and; or pigments.

20. The polymerizable dental appliance or prosthetic material of claim 19, wherein the filler is present in a range of from 0-90 wt %, 0-50 wt %, or 0-25 wt % of the total material weight, and optionally a pigment in a range of from about 0.0001-5 wt %, 0.001-1 wt %, or 0.003-0.5 wt % of the total material weight.

21. A dispensing device comprising an unpolyrnerized quantity of the polymerizable dental material of claim 19.

22. A PCL urethane (meth)acrylate monomer comprising a chemical structure according to Formula (I): 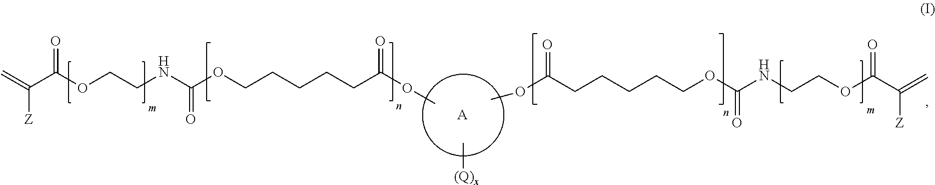
wherein A=aliphatic, aromatic, alkoxyalkyl, alkoxy, hydroxyalkyl, or alkoxycarbonyl core structure; independently each n=0-12, wherein at least one n≠0; x=0-6; each m=1-5; each Z=CH₃ or H; and Q=OH or OR, and wherein

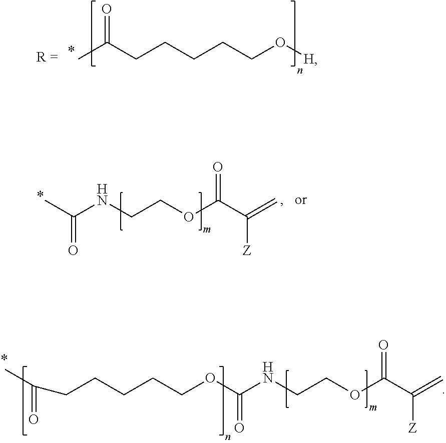

23. The PCL urethane (meth)acrylate monomer according to claim 22, comprising a chemical structure according to Formula (Ia): 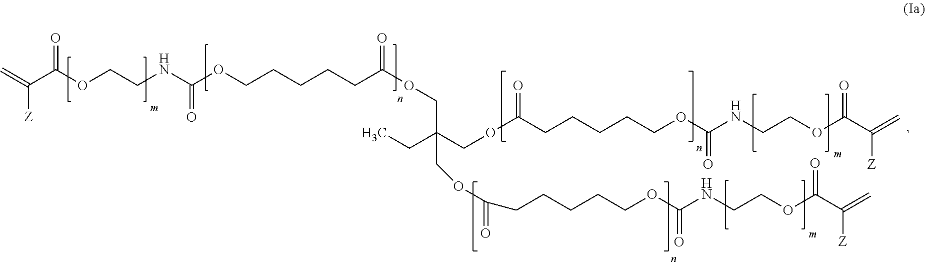
wherein each m is independently=1 to 5; each Z is independently=CH₃ or H; and each n is independently=0 to 12, wherein at least one n≠0.

24. The PCL urethane (meth)acrylate monomer according to claim 22, comprising a chemical structure according to Formula (Ib): 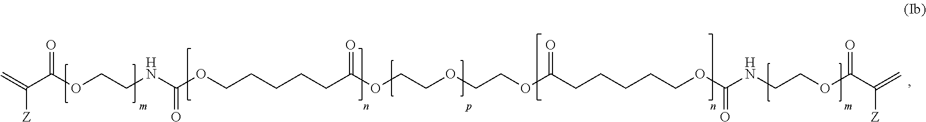
wherein each m is independently=1 to 5; each Z is independently=CH₃ or H; each n is independently =0 to 12, wherein at least one n≠0; and p=0 to 12.

25. A PCL tetraurethane di(meth)acrylate monomer according to Formula (IIa) or (IIb): 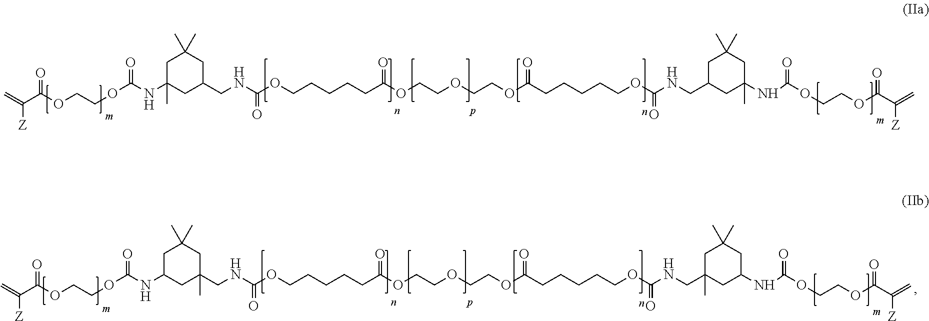
wherein n=1 to 10, m=1 to 5, p=0 to 12, and z=H or CH₃; optionally wherein n=1 to 5, m=1 to 3, p=1 to 6.
